(19) United States
(12) Patent Application Publication
(10) Pub. No.: US 2023/0347631 A1
(43) Pub. Date: Nov. 2, 2023

(54) MULTILAYER STRUCTURE AND PACKAGING CONTAINER COMPRISING SAME

(71) Applicant: KURARAY CO., LTD., Okayama (JP)

(72) Inventors: Takeshi Sakano, Kurashiki-shi, Okayama (JP); Kentaro Yoshida, Kurashiki-shi, Okayama (JP); Satoshi Ishiuchi, Kurashiki-shi, Okayama (JP); Tatsuya Oshita, Kurashiki-shi, Okayama (JP)

(73) Assignee: KURARAY CO., LTD., Okayama (JP)

(21) Appl. No.: 18/025,777

(22) PCT Filed: Sep. 9, 2021
(86) PCT No.: PCT/JP2021/033219

§ 371 Date: Mar. 10, 2023

(30) Foreign Application Priority Data
Sep. 10, 2020 (JP) 2020-151761
Sep. 10, 2020 (JP) 2020-151772

(51) Int. Cl. B32B 27/08; B32B 27/30; B32B 27/32; C08L 23/20

(52) U.S. Cl. CPC B32B 27/08; B32B 27/306; B32B 27/32; C08L 23/20; B32B 2255/10; B32B 2255/20; B32B 2305/026; B32B 2307/7376; B32B 2307/74; B32B 2553/00

(57) ABSTRACT

The present disclosure provides a multilayer structure in which a layer (A) made of a polyolefin resin composition (a), an oxygen barrier layer (B) and a sealant layer (C) are laminated in this sequence.

### TECHNICAL FIELD

The present invention relates to a multilayer structure having a layer comprising an ethylene-vinyl alcohol copolymer, and a packaging container therewith.

### BACKGROUND ART

Nowadays, materials for containers for retorting foods such as vegetables and seafoods are exclusively glasses, metals and metal foils. Recently, rigid or semi-rigid plastic containers, however, have come into common use as containers for retorting other foods such as soups and pet foods.

Demand for so-called post-consumer recycling (hereinafter, sometimes simply abbreviated as recycling) in which packaging materials consumed in the market are recovered and recycled, has been globally increased due to environmental problems and waste problems. Recycling is generally conducted by a process comprising cutting a recovered packaging material and, after, if necessary, sorting and washing, melt-kneading it using an extruder.

An ethylene-vinyl alcohol copolymer (hereinafter, sometimes abbreviated as “EVOH”) has been employed as a barrier resin for plastic containers because of its good processability and excellent gas barrier properties.

It is known that due to its chemical structure, EVOH tends to decrease its gas barrier properties in environments where a relative humidity exceeds 85%. It is believed to be because water acts as a plasticizer for EVOH, weakening hydrogen bonds in amorphous regions in EVOH to increase its free volume, so that gas diffusion is increased in the polymer matrix. Therefore, when a package product is subjected to typical steam retort treatment, that is, treating the package product at 110 to 132° C. for 15 to 80 minutes, an oxygen transmission rate of EVOH dramatically increases, causing oxidative deterioration of foods, resulting in deterioration of flavor and a shorter shelf life.

When EVOH is used, gas barrier properties of a container can be appropriately maintained by keeping EVOH as dry as possible. Patent Reference No.1 describes that for a multilayer structure having an inner and an outer layers made of a polymer film and an intermediate layer made of an EVOH film, where the outer polymer film layer has a greater moisture permeability and is thinner than the inner polymer film layer, the intermediate layer is dried faster after retorting and thus the multilayer structure rapidly recovers its oxygen barrier properties.

Patent Reference No.2 has disclosed a packaging material, in which an oriented polypropylene film layer (OPP), an aluminum-deposited oriented ethylene-vinyl alcohol copolymer film layer (VM-EVOH), and an unstretched polyolefin layer are laminated in this sequence. It has described that the packaging material has high light shielding and oxygen barrier properties, and since the entire packaging material is soft, generation of pinholes caused by bending due to vibration or the like is prevented and content preservability is improved.

Polypropylene resins are often used as a resin for a surface layer of a multi-layer structure such as retort pouches in the light of heat resistance, and a thick film of about 30 to 50 µm is usually used for the surface layer. Polypropylene has a low water vapor transmission rate, and therefore, in such a thickness range, moisture that has penetrated into the EVOH in the middle layer of the pouch during retorting remains for a long time, resulting in poor oxygen barrier properties for a long period and enhancing oxidative deterioration of the food inside. When a polypropylene resin is used as a surface layer of a retort pouch, a water vapor transmission rate can be increased by making the surface layer thinner, allowing moisture in the EVOH contained inside the multilayer structure to be removed quickly after retorting, and allowing the oxygen barrier properties which have been deteriorated during retorting to be recovered quickly.

### PRIOR ART REFERENCES

### Patent References

Patent Reference No.1: JP 2-231138A
Patent Reference No.2: JP 2006-193196A

### SUMMARY OF THE INVENTION

### Problems to be Solved by the Invention

In the multilayer structure described in Patent Reference No.1, a polyamide or polyester is used for the outer layer. However, when the multilayer structure with a layer made of a polyamide was melt-kneaded, a resulting resin composition was colored and the polyester was not uniformly mixed with the other components. Therefore, there are problems such as difficulty in recycling said multilayer structure, or limitation in applications due to poor appearance and insufficient mechanical strength of the recycled resin product. Furthermore, it is even more difficult to recycle the recycled resin products again, and thus there is also a problem that they cannot be recycled repeatedly. As a result, such a resin product less contributes to realization of “cyclical economy” in which resin products are cycled and reused without being disposed. Furthermore, in Patent Reference No.2, there are no descriptions regarding change in oxygen barrier properties when a packaging material is subjected to typical steam retorting.

To solve the above problems, an objective of the present invention is to provide a multilayer structure having high gas barrier properties even after being treated with water vapor or hot water while exhibiting excellent recyclability.

### Means for Solving the Problems

The above problems can be solved by providing a multilayer structure in which a layer (A) made of a polyolefin resin composition (a), an oxygen barrier layer (B) and a sealant layer (C) are laminated in this sequence, wherein the resin composition (a) comprises a polyolefin having a melting point of 130° C. or higher as a main component; the layer (A) has a water vapor transmission rate of 10 g/m²•day or more at 40° C. and a humidity of 90%; the layer (A) has a thickness of 5 to 150 µm; and the layer (B) comprises EVOH as a main component.

Here, preferably the multilayer structure further comprises a water-vapor barrier layer (D) between the layer (B) and layer (C), wherein the layer (D) is a deposited aluminum layer or a deposited layer made of an inorganic oxide, and all resin components contained in all layers have a melting point of 240° C. or lower, or are amorphous.

Preferably, the polyolefin is a polymethylpentene or a polypropylene. More preferably, the polyolefin is a polymethylpentene. Also more preferably, the polyolefin is a polypropylene. Also preferably, the polyolefin resin composition (a) further comprises an ethylene-α-olefin copolymer or a hydrogenated styrene thermoplastic elastomer in 0.1 to 40 % by mass.

Also preferably, the layer (A) is stretched by 2 to 15 times at least in one direction. Also preferably, the layer (A) has a density of 0.83 to 0.90 g/cm³. Also preferably, the layer (A) is porous.

Preferably, an ethylene unit content of the EVOH is 20 to 60 mol%. Also preferably, the layer (B) further comprises an oxygen-absorbing resin. More preferably, the oxygen-absorbing resin comprises a carbon-carbon double bond and the layer (B) comprises a transition metal catalyst. Also more preferably, the oxygen-absorbing resin is a polyoctenylene or an ethylene-α-olefin-5-ethylidene-2-norbornene copolymer.

Preferably, the layer (B) comprises a layer (B1) and a layer (B2), and a difference in an ethylene unit content between the EVOH contained in the layer (B1) and the EVOH contained in the layer (B2) is 3 mol% or more. Also preferably, the layer (B) further comprises an aliphatic polyamide in 25 parts by mass or less based on 100 parts by mass of the ethylene-vinyl alcohol copolymer. Also preferably, the layer (C) comprises a polypropylene. Also preferably, the layer (D) has a thickness of 10 to 1000 nm. Also preferably, the multilayer structure has a total thickness of 10 to 200 µm.

A packaging container made of the multilayer structure is a preferable embodiment of the present invention. Preferably, the packaging container is a stand-up pouch. Also preferably, the packaging container is for sterilization treatment with water vapor or hot water. A package product, wherein a content is filled in the packaging container is also a preferable embodiment of the present invention. A more preferable embodiment is a sterilization treatment method comprising sterilizing the package product with water vapor or hot water at 70° C. to 140° C. A recovery method comprising melt-kneading the multilayer structure is also a preferable embodiment of the present invention.

### EFFECTS OF THE INVENTION

A multilayer structure of the present invention has high gas barrier properties even after being treated with water vapor or hot water. In addition, a resin composition obtained by melt-kneading the multilayer structure has little coloration and high transparency, allowing the resin composition to be suitably reused as a raw material for the multilayer structure or the like, and giving the multilayer structure excellent recyclability. Such a multilayer structure is suitably used as a packaging container or the like for sterilization treatment with water vapor or hot water.

### BRIEF DESCRIPTION OF DRAWINGS

FIG. 1 is a ¹H NMR spectrum of a biaxially oriented polypropylene film “Pylen film-OT P2161” manufactured by Toyobo Co., Ltd., used in Example 11 and Comparative Examples 1, 2, 8 and 9.

FIG. 2 is a ¹H NMR spectrum of a propylene elastomer (ethylene-propylene copolymer) “Vistamaxx 6102” manufactured by Exxon Mobil Corporation, used in Examples 13 to 16, 32 and 33, and Comparative Examples 5 to 7, 13 and 14.

### MODES FOR CARRYING OUT THE INVENTION

A multilayer structure of the present invention is a multilayer structure in which a layer (A) made of a polyolefin resin composition (a), an oxygen barrier layer (B) and a sealant layer (C) are laminated in this sequence, wherein the resin composition (a) comprises a polyolefin having a melting point of 130° C. or higher as a main component; the layer (A) has a water vapor transmission rate of 10 g/m²•day or more at 40° C. and a humidity of 90%; the layer (A) has a thickness of 5 to 150 µm; and the layer (B) comprises EVOH as a main component. The multilayer structure has the layer (A) having higher water vapor transmission rate than oxygen barrier layer (B) laminated thereover. Thus, after EVOH in the oxygen barrier layer (B) absorbs moisture, the EVOH is rapidly dried. Therefore, the multilayer structure has high gas barrier properties after being treated with water vapor or hot water. In addition, a resin composition obtained by melt-kneading the multilayer structure has little coloration and high transparency, allowing it to be suitably reused as a raw material for the multilayer structure or the like, and giving the multilayer structure excellent recyclability. In the light of improving gas barrier properties, the layer (A) is preferably an outer layer.

The polyolefin resin composition (a) constituting the layer (A) contains a polyolefin having a melting point of 130° C. or higher as a main component. A content of the polyolefin having a melting point of 130° C. or higher in the polyolefin resin composition (a) must be 50% by mass or more and is preferably 60% by mass or more, more preferably 70% by mass or more, further preferably 80% by mass or more, particularly preferably 85 % by mass or more. When more than one polyolefin having a melting point of 130° C. or higher are contained in the polyolefin resin composition (a), the total amount of these can be within the above range. A mass ratio (polyolefin/the total of the resins) of the polyolefin having a melting point of 130° C. or higher to the total mass of the resins contained in the polyolefin resin composition (a) is preferably 0.6 or more, more preferably 0.7 or more, further preferably 0.8 or more, particularly preferably 0.85 or more.

A melting point of the polyolefin contained in the polyolefin resin composition (a) as a main component is 130° C. or higher. This prevents the resin from fusing to a seal bar during heat sealing, thereby enabling continuous heat sealing process and improving productivity. A melting point of the polyolefin is more preferably 140° C. or higher, further preferably 155° C. or higher, particularly preferably 180° C. or higher, most preferably 200° C. or higher. Meanwhile, a melting point of the polyolefin is generally 250° C. or lower. A melting point of each resin contained in the polyolefin resin composition (a) or a resin contained in the layer (B) or (C) described below can be determined from an endothermic peak as determined by measurement using a differential scanning calorimeter, and specifically, the method described in the Examples is employed. Alternatively, a melting point of the polyolefin as a main component can be determined by conducting measurement for the polyolefin resin composition (a) with a differential scanning calorimeter. Mixing said polyolefin with other components would not generally cause substantial changes in a measured value. When the polyolefin resin composition (a) has multiple endothermic peaks with a peak temperature of 130° C. or higher, a melting point of the polyolefin as a main component is determined from an endothermic peak at the highest temperature.

The polyolefin having a melting point of 130° C. or higher contained in the polyolefin resin composition (a) as a main component preferably has a fusion enthalpy of 1 to 100 J/g. With the fusion enthalpy of 1 J/g or more, fusion of a resin to a seal bar during heat sealing is further prevented. In this light, the fusion enthalpy is more preferably 7 J/g or more, further preferably 10 J/g or more, particularly preferably 20 J/g or more, most preferably 40 J/g or more. Meanwhile, with the fusion enthalpy being 100 J/g or less, the multilayer structure can be easily melted during a recycling process. In this light, the fusion enthalpy is more preferably 90 J/g or less, further preferably 80 J/g or less, particularly preferably 60 J/g or less, most preferably 40 J/g or less. A fusion enthalpy of the polyolefin as a main component of the polyolefin resin composition (a) can be determined as described in Examples.

There are no particular restrictions to the polyolefin contained in the polyolefin resin composition (a) as a main component as long as it has a melting point of 130° C. or higher, and a polymethylpentene and a polypropylene are preferred.

In the light of providing a multilayer structure exhibiting particularly higher gas barrier properties after being treated with water vapor or hot water and recyclability, the polyolefin having a melting point of 130° C. or higher is more preferably a polymethylpentene. The polymethylpentene can be provided by polymerizing methylpentene. The methylpentene is preferably 4-methyl-1-pentene. A content of methylpentene units in the polymethylpentene is generally 50 % by mass or more, preferably 70 % by mass or more, more preferably 80 % by mass or more.

As long as the effects of the present invention are not impaired, the polymethylpentene can contain monomer units other than a methylpentene unit. Examples of the other monomer units include units derived from ethylene; α-olefins other than methylpentene such as propylene, 1-butene, and 1-hexene; (meth)acrylic acid esters; unsaturated carboxylic acids such as maleic acid, fumaric acid and itaconic acid; alkyl vinyl ethers; N-(2-dimethylaminoethyl)methacrylamide or its quaternized products; N-vinylimidazole or its quaternized products; N-vinylpyrrolidone; N,N-butoxymethylacrylamide; vinyltrimethoxysilane; vinylmethyldimethoxysilane; vinyldimethylmethoxysilane, or the like. A content of monomer units other than α-olefin units contained in the polymethylpentene is preferably 5% by mass or less.

A melt flow rate (MFR, 260° C., under 5000 g load) of the polymethylpentene is generally 5 to 250 g/10 min. In the light of easier melting of the multilayer structure during recycling, a fusion enthalpy of the polymethylpentene is preferably 1 to 30 J/g.

From an aspect of cost, the polyolefin having a melting point of 130° C. or higher is more preferably a polypropylene. There are no particular restrictions to a propylene unit content in the polypropylene as long as a melting point is 130° C. or higher, and it is generally more than 95% by mass, preferably 97% by mass or more, more preferably 98% by mass or more. In the light of preventing fusion of a resin to a seal bar during heat sealing, the polypropylene preferably contains substantially propylene units alone. A melt flow rate (MFR, 230° C., under a load of 2160 g) of the polypropylene is generally 0.1 to 100 g/10 min, and is more preferably 1 to 10 g/10 min in the light of improving thickness uniformity during extrusion molding. In the light of preventing fusion of a resin to a seal bar during heat sealing, a fusion enthalpy of the polypropylene is preferably 40 to 100 J/g.

As long as the effects of the present invention are not impaired, the polypropylene can contain monomer units other than propylene units. Examples of the other monomer units include units derived from ethylene; and units derived from α-olefins other than propylene units such as 1-butene, 1-hexene, 4-methyl-1-pentene and 1-octene. A content of the other monomer units contained in the polypropylene is generally less than 5% by mass, preferably 3% by mass or less, more preferably 2% by mass or less. When a content of the other monomer units such as ethylene units or α-olefin units other than propylene units contained in the polypropylene is less than 5 % by mass, a melting point of the polypropylene is 135° C. or higher. The polypropylene containing the other monomer units in less than 5% by mass is generally referred to as random polypropylene, which is preferable as a polypropylene having a melting point of 130° C. or higher contained in the polyolefin resin composition (a) as a main component in the light of transparency and further improving gas barrier properties after treatment with water vapor or hot water. When a polypropylene having a melting point of 130° C. or higher contained in the polyolefin resin composition (a) as a main component contains monomer units other than propylene units, its content is preferably 0.1 mol% or more.

In the light of further improving gas barrier properties after treatment with water vapor or hot water, the polyolefin resin composition (a) preferably further contains an ethylene-α-olefin copolymer or a hydrogenated styrene thermoplastic elastomer, more preferably an ethylene-α-olefin copolymer.

Examples of α-olefin units contained in the ethylene-α-olefin copolymer include propylene units, 1-butene units, 1-hexene units, 4-methyl-1-pentene units and 1-octene units, preferably propylene units. A carbon number of the α-olefin units is preferably 8 or less. A content of ethylene units contained in the ethylene-α-olefin copolymer is generally 5 to 40% by mass. Meanwhile, a content of α-olefin units contained in the ethylene-α-olefin copolymer is generally 60 to 95% by mass. When α-olefin units are propylene units, a content of propylene units contained in the ethylene-propylene copolymer is preferably 5 to 95% by mass. In particular, it is more preferable that a propylene unit content is 5 to 40% by mass and an ethylene unit content is 60 to 95% by mass, or a propylene unit content is 60 to 95% by mass and an ethylene unit content is 5 to 40% by mass.

In the light of further improving gas barrier properties after treatment with water vapor or hot water, a melting point of the ethylene-α-olefin copolymer is lower than 140° C. The melting point is more preferably less than 130° C., further preferably 110° C. or lower, particularly preferably 90° C. or lower, most preferably 70° C. or lower. Meanwhile, the melting point is generally 20° C. or higher.

Examples of styrene units contained in the hydrogenated styrene thermoplastic elastomer include units derived from styrene, α-methylstyrene, 2-methylstyrene, and 4-methylstyrene. A content of the styrene units in the hydrogenated styrene thermoplastic elastomer is generally 10 to 70% by mass.

Also preferably, the hydrogenated styrene thermoplastic elastomer further contains units derived from a diene such as 1,3-butadiene, isoprene and 1,3-pentadiene. A content of the units derived from the diene in the hydrogenated styrene thermoplastic elastomer is generally 30 to 90% by mass.

The hydrogenated styrene thermoplastic elastomer is preferably a block copolymer comprising a styrene polymer block (b1) and a hydrogenated diene polymer block (b2). There are no particular restrictions to the structure of the block copolymer as long as the block copolymer comprises at least one polymer block (b1) and at least one polymer block (b2) in one molecule. The block copolymer is typically a diblock structure represented by b1-b2, a triblock structure represented by b1-b2-b1 or b2-b1-b2, a tetrablock structure represented by b1-b2-b1-b2, a polyblock structure in which five or more of b1 and b2 are linearly bonded, or a mixture thereof.

Specific examples of the hydrogenated styrene thermoplastic elastomer include SEBS as a hydrogenated triblock copolymer (SBS) of styrenebutadiene-styrene, SEPS as a hydrogenated triblock copolymer (SIS) of styrene-isoprene-styrene, and SEEPS as a hydrogenated triblock copolymer (SIBS) of styrene-isoprene/butadiene-styrene.

In the light of further improving gas barrier properties after treatment with water vapor or hot water, it is also preferable that the polyolefin resin composition (a) further comprises a polyethylene having a melting point of lower than 130° C. Specific Examples of such a polyethylene include polyethylenes such as low-density polyethylenes, medium-density polyethylenes, high-density polyethylenes, straight-chain low-density polyethylenes, which have a melting point of lower than 130° C.

In the light of further improving gas barrier properties after treatment with water vapor or hot water, it is also preferable that the polyolefin resin composition (a) further comprises a propylene-α-olefin copolymer having a melting point of lower than 130° C. Preferably, α-olefin units contained in the propylene-α-olefin copolymer are butene units. A content of propylene units in the propylene-α-olefin copolymer is preferably 70 to 95% by mass. A content of α-olefin units in the propylene-α-olefin copolymer is preferably 5 to 30% by mass.

The total content of an ethylene-α-olefin copolymer, a hydrogenated styrene thermoplastic elastomer, and a polyethylene and a propylene-α-olefin copolymer having a melting point of lower than 130° C. in the polyolefin resin composition (a) is preferably 0.1 to 40% by mass. With the total content being 0.1 % by mass or more, gas barrier properties after treatment with water vapor or hot water is further improved. The total content is more preferably 0.5 % by mass or more, further preferably 1% by mass or more, particularly preferably 3% by mass or more, most preferably 5% by mass or more. Meanwhile, with the total content being 40% by mass or less, fusion of a resin to a seal bar during heat sealing or mutual fusion of pouches when the pouches are piled and retorted is inhibited. The total content is more preferably 30% by mass or less, further preferably 20% by mass or less, particularly preferably 15% by mass or less. A polypropylene containing an ethylene-α-olefin copolymer or a hydrogenated styrene thermoplastic elastomer is generally referred to as a block polypropylene, which is preferable as the polyolefin resin composition (a).

As long as the effects of the present invention are not impaired, the polyolefin resin composition (a) can contain additives other than a polyolefin having a melting point of 130° C. or higher, an ethylene-α-olefin copolymer, a hydrogenated styrene thermoplastic elastomer and a polyethylene having a melting point of lower than 130° C. Examples of the other additives include resins other than a polyolefin having a melting point of 130° C. or higher, an ethylene-α-olefin copolymer, a hydrogenated styrene thermoplastic elastomer and a polyethylene having a melting point of lower than 130° C., dispersants, plasticizers, stabilizers, surfactants, coloring materials, UV absorbers, antistatic agents, cross-linking agents, metal salts, fillers, and reinforcing agents such as various fibers.

In the light of improving mechanical properties of a multilayer structure obtained, the layer (A) is stretched preferably at least in one direction, more preferably in one or two directions, further preferably in two directions. When the layer (A) is oriented in two directions, the two directions are preferably orthogonal. A stretching ratio in each direction is preferably 2 to 15 times. If a stretching ratio is too large, orientational crystallization increases so that water vapor transmission rate decreases, and therefore, the stretching ratio is more preferably 10 times or less, further preferably 8 times or less, particularly preferably 5 times or less.

A density of the layer (A) is generally 0.83 to 0.95 g/cm³. A density of the layer (A) is preferably 0.90 g/cm³ or less. Thus, with a relatively lower density of the layer (A), gas barrier properties after treatment with water vapor or hot water are further improved even when the layer (A) is not porous. The density is more preferably 0.87 g/cm³ or less, further preferably 0.86 g/cm³ or less, particularly preferably 0.85 g/cm³ or less, most preferably 0.84 g/cm³ or less.

In the light of further improving gas barrier properties after treatment with water vapor or hot water, the layer (A) is preferably porous. More preferably, the layer (A) has through-holes. A proportion of pores per unit area of a film is preferably 1 to 20%. An average pore size of the pores is preferably 5 to 500 µm. Meanwhile, in the light of excellent appearance and printability, the layer (A) is preferably nonporous. Specifically, the layer (A) preferably has no pores. Furthermore, the layer (A) preferably has no through-holes.

There will be described an integral ratio of a specific chemical shift [reference: TMS (tetramethylsilane)] in a spectrum obtained by ¹H NMR measurement of the polyolefin resin composition (a) constituting the layer (A).

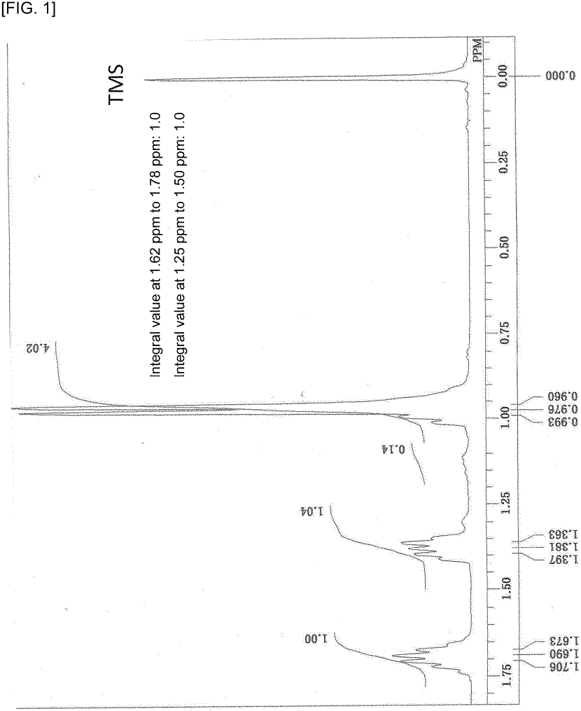

In the ¹H NMR spectrum of the polypropylene having a melting point of 130° C. or higher, a peak corresponding to the tertiary hydrogen in the polypropylene is observed at a chemical shift (reference: TMS) of 1.62 ppm to 1.78 ppm. In the ¹H NMR spectrum of the polypropylene with an isotactic steric structure, a peak corresponding to one of the two secondary hydrogens in the polypropylene is observed at a chemical shift of 1.25 ppm to 1.50 ppm. The integral ratio (Y/X) of an integral value Y of the peak at a chemical shift of 1.25 ppm to 1.50 ppm to an integral value X of the peak at a chemical shift of 1.62 ppm to 1.78 ppm in the polypropylene with an isotactic steric structure is 1. FIG. 1 shows a ¹H NMR spectrum of a biaxially oriented polypropylene film “Pylen-OT P2161” manufactured by Toyobo Co., Ltd., used in Example 11 and Comparative Examples 1, 2, 8 and 9 described later. The integral ratio (Y/X) in the ¹H NMR spectrum of said biaxially oriented polypropylene film is 1.0.

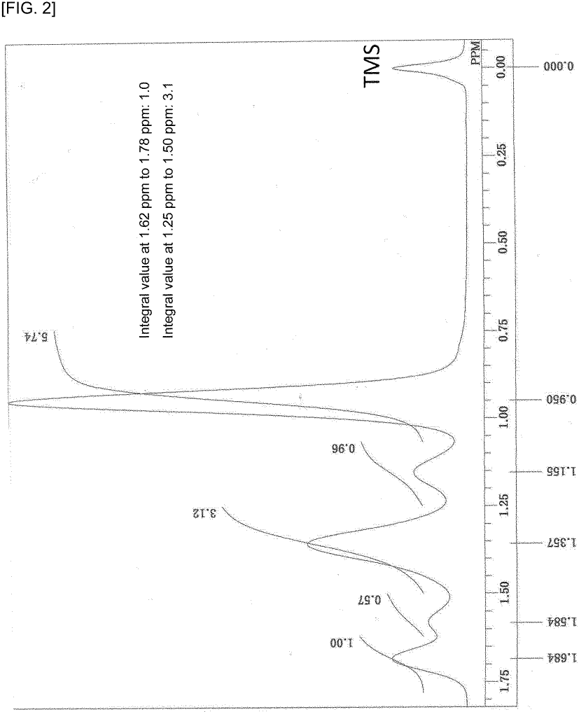

The integral ratio (Y/X) of the integral value Y of the peak at a chemical shift of 1.25 ppm to 1.50 ppm to the integral value X of the peak at a chemical shift of 1.62 ppm to 1.78 ppm in the ¹H NMR spectrum of said ethylene-α-olefin copolymer contained in the resin composition (a) is generally 1 or more. FIG. 2 shows a ¹H NMR spectrum of an ethylene-propylene copolymer “Vistamaxx 6102” (ethylene: 16% by mass, propylene: 84% by mass) manufactured by Exxon Mobil Corporation, used in Examples 13 and so on described later. The integral ratio (Y/X) in the ¹H NMR spectrum of said ethylene-propylene copolymer is 3.1. One of the reasons why said integral ratio (Y/X) increases is that peaks derived from a secondary hydrogen constituting the main chain of ethylene and α-olefin units are observed at chemical shifts of 1.25 ppm to 1.50 ppm.

When the ethylene-α-olefin copolymer or the propylene-α-olefin copolymer is mixed with the polypropylene, the integral ratio (Y/X) in a ¹H NMR spectrum of the resin composition (a) increases in proportion to a blending ratio of the ethylene-α-olefin copolymer or the propylene-α-olefin copolymer, and is, therefore, 1 or more.

When the resin composition (a) contains polypropylene having a melting point of 130° C. or higher as a main component, the integral ratio (Y/X) of the integral value Y of the peak with a chemical shift of 1.25 ppm to 1.50 ppm to the integral value X of the peak with a chemical shift of 1.62 ppm to 1.78 ppm in the ¹H NMR spectrum of the resin composition (a) is preferably 1.2 or more, more preferably 1.5 or more, further preferably 2 or more, particularly preferably 3 or more. Meanwhile, when the resin composition (a) contains a polypropylene having a melting point of 130° C. or higher as a main component, the integral ratio (Y/X) of the resin composition (a) is generally 200 or less, preferably 50 or less, more preferably 20 or less, further preferably 15 or less, particularly preferably 10 or less. With the polyolefin resin in the layer (A) having the above integral ratio (Y/X), water vapor transmission rate of the layer (A) further increases, so that an oxygen concentration in the container after hot water sterilization treatment can be maintained at a further lower level, while occurrence of fusion between pouches during hot water sterilization treatment can be further inhibited. When the resin composition (a) contains the polypropylene having a melting point of 130° C. or higher as a main component and the integral ratio (Y/X) is within the above range, it is preferable that said resin composition (a) further contains the ethylene-α-olefin copolymer or the propylene-α-olefin copolymer and the layer (a) is nonporous.

A water vapor transmission rate of layer (A) at 40° C. and humidity of 90 % must be 10 g/m²•day or more. With these conditions being met, EVOH in the oxygen barrier layer (B) which has absorbed moisture can be dried in a short time. Thus, the multilayer structure exhibits high gas barrier properties even after treatment with water vapor or hot water. The water vapor transmission rate is preferably 20 g/m²•day or more, more preferably 30 g/m²•day or more, further preferably 60 g/m²•day or more, further preferably 100 g/m²•day or more, particularly preferably 200 g/m²•day or more, most preferably 300 g/m²•day or more. When the layer (A) is porous, the water vapor transmission rate is preferably 500 g/m²•day or more, more preferably 1000 g/m²•day or more, further preferably 2000 g/m²•day or more. Meanwhile, the water vapor transmission rate is generally 5000 g/m²•day or less. A water vapor transmission rate of the layer (A) can be determined by measuring a monolayer film used for forming the layer (A) in the process for producing the multilayer structure. When the layer (A) and other layers are simultaneously formed by, for example, co-extrusion in the process for producing the multilayer structure, a measurement value for a monolayer film produced under the same conditions except that only the layer (A) is formed is employed as a water vapor transmission rate of the layer (A). Specifically, a water vapor transmission rate of the layer (A) is determined as described in Examples.

A thickness of the layer (A) is 5 to 150 µm. With the thickness being 5 µm or more, mechanical properties of a multilayer structure provided are improved, giving a multilayer structure exhibiting excellent rupture resistance. The thickness is preferably 8 µm or more, more preferably 15 µm or more, further preferably 20 µm or more. Meanwhile, with the thickness being 150 µm or less, a water vapor transmission rate of the layer (B) can be easily increased. The thickness is more preferably 120 µm or less, further preferably 80 µm or less, particularly preferably 50 µm or less, most preferably 30 µm or less.

A multilayer structure of the present invention has an oxygen barrier layer (B) comprising EVOH as a main component. Since EVOH has excellent gas barrier properties, a multilayer structure having a layer comprising the EVOH as a main component is suitably used as, for example, a packaging container for sterilization treatment with water vapor or hot water. Furthermore, EVOH can be easily melt-mixed with the polyolefin resin composition (a), so that it can provide a multilayer structure exhibiting excellent recyclability. A content of the EVOH in the oxygen barrier layer (B) must be 50 % by mass or more, and is preferably 70 % by mass or more, more preferably 90 % by mass or more, further preferably 95 % by mass or more. A mass ratio (EVOH/total of resins) of EVOH to the total of the resins contained in the oxygen barrier layer (B) is preferably 0.7 or more, more preferably 0.9 or more, further preferably 0.95 or more.

EVOH can be generally produced by saponifying an ethylene-vinyl ester copolymer obtained by polymerization of ethylene and a vinyl ester. An ethylene unit content of EVOH is preferably 20 to 60 mol%. With an ethylene unit content being 20 mol% or more, the multilayer structure has improved melt-formability. The ethylene unit content is more preferably 25 mol% or more. Meanwhile, with the ethylene unit content being 60 mol% or less, gas barrier properties of the multilayer structure are further improved. The ethylene unit content is preferably 50 mol% or less, more preferably 40 mol% or less. A saponification degree of EVOH is preferably 85 mol% or more. A saponification degree means a ratio of the number of vinyl alcohol units to the total number of vinyl alcohol units and vinylester units in EVOH. With the saponification degree being 85 mol% or more, gas barrier properties of the multilayer structure are further improved. The saponification degree is more preferably 95 mol% or more, further preferably 99 mol% or more. An ethylene unit content and a saponification degree of EVOH can be determined by¹H NMR spectrometry.

EVOH can contain monomer units other than ethylene, a vinyl ester and a vinyl alcohol as long as the effects of the present invention are not impaired. A content of the other monomer units is preferably 5 % by mass or less, more preferably 3 % by mass or less, further preferably 1 % by mass or less, particularly preferably substantially absent. Examples of the other monomer units include α-olefins such as propylene, 1-butene, 1-hexene and 4-methyl-1-pentene; (meth)acryic acid esters; unsaturated carboxylic acids such as maleic acid, fumaric acid and itaconic acid; alkyl vinyl ethers; N-(2-dimethylaminoethyl)methacrylamide or quaternary salts thereof; N-vinylimidazole or quaternary salts thereof; N-vinylpyrrolidone; N,N-butoxymethylacrylamide; vinyltrimethoxysilane; vinylmethyldimethoxysilane; and vinyldimethylmethoxysilane.

An MFR (190° C., under a load of 2.16 kg) of EVOH is preferably 0.1 to 50 g/10 min. The MFR of EVOH is more preferably 1 g/10 min or more, further preferably 2 g/10 min or more. Meanwhile, an MFR of EVOH is more preferably 30 g/10 min or less, further preferably 15 g/10 min or less. With an MFR of EVOH being within the above range, melt formability of the multilayer structure is further improved.

In the light of further improving gas barrier properties after treatment with water vapor or hot water, it is preferable that the layer (B) further contains an oxygen-absorbing resin. Preferable examples of the oxygen-absorbing resin include polyoctenylene; and resins having a carbon-carbon double bond including an ethylene-α-olefin-diene copolymer such as ethylene-propylene-5-ethylidene-2-norbornene copolymer. It is further preferable that the layer (B) contains a resin having a carbon-carbon double bond and a transition metal catalyst. When the carbon-carbon double bond in the resin is oxidized, oxygen atoms passing through the layer (B) are captured, and therefore, gas barrier properties are further improved. Here, since the layer (B) further contains a transition metal catalyst, oxidation of the carbon-carbon double bond in the above resin is promoted, resulting in further improved gas barrier properties. A “carbon-carbon double bond” as referred herein does not include double bonds contained in an aromatic ring.

In the light of inhibiting odor during oxidation of the oxygen-absorbing resin, the resin having a carbon-carbon double bond is preferably an ethylene-α-olefin-diene copolymer.

Examples of the transition metal catalyst preferably include transition metal salts such as iron salts, nickel salts, copper salts, manganese salts and cobalt salts, more preferably cobalt salts. An anion species of the transition metal salt is suitably a carboxylic acid anion. Examples of the carboxylic acid include, but not limited to, acetic acid, stearic acid, acetylacetone, dimethyldithiocarbamic acid, palmitic acid, 2-ethylhexanoic acid, neodecanoic acid, linoleic acid, tall oil acid, oleic acid, capric acid and naphthenic acid. Among these, stearic acid is preferable. Examples of a particularly suitable salt used as the transition metal salt include cobalt stearate, cobalt 2-ethylhexanoate and cobalt neodecanoate. The transition metal salt can be a so-called ionomer, which has an ionic polymer as a counter ion.

When the layer (B) further contains an oxygen-absorbing resin, its content is preferably 1 to 30 parts by mass, more preferably 5 to 20 parts by mass based on 100 parts by mass of the EVOH. A content of the transition metal catalyst in the layer (B) is preferably 1 to 50,000 ppm in terms of the metal element. There are no particular restrictions to a method for blending the oxygen-absorbing resin and the transition metal catalyst, and it is preferable that the oxygen-absorbing resin is blended by melt-kneading together with the transition metal catalyst.

For the EVOH containing an oxygen-absorbing resin used for the layer (B), the amount of oxygen absorption for seven days under the conditions of 60° C. and 100 %RH is preferably 0.1 to 300 cc/g, more preferably 0.5 to 200 cc/g, further preferably 10 to 50 cc/g, particularly preferably 20 to 30 cc/g. With the EVOH containing an oxygen-absorbing resin being capable of absorbing oxygen within such a range, a multilayer structure in the present invention can maintain high oxygen barrier properties for a long period and can maintain high oxygen barrier properties even after retorting.

As long as the effects of the present invention are not impaired, the layer (B) can or cannot further contain a polyamide. With the layer (B) containing a small amount of polyamide, appearance of the multilayer structure is further improved by, for example, preventing wrinkle formation, even after treatment with water vapor or hot water. In the light of achieving such effects, a content of the polyamide in the layer (B) is preferably 1% by mass or more, more preferably 5% by mass or more. Furthermore, a content of the polyamide in the layer (B) is preferably 1 part by mass or more, more preferably 5 parts by mass or more based on 100 parts by mass of the EVOH. Meanwhile, in the light of further improving recyclability, a content of the polyamide in the layer (B) is preferably 20% by mass or less, more preferably 15% by mass or less, further preferably 5% by mass or less, particularly preferably 1% by mass or less. Furthermore, a content of the polyamide in the layer (B) is preferably 25 parts by mass or less, more preferably 20 parts by mass or less based on 100 parts by mass of the EVOH.

Examples of the polyamide include polycaproamide (Nylon 6), poly-ω-aminoheptanoic acid (Nylon 7), poly-ω-aminononanoic acid (Nylon 9), polyundecaneamide (Nylon 11), polylauryl lactam (Nylon 12), polyethylenediamine adipamide (Nylon 26), polytetramethylene adipamide (Nylon 46), polyhexamethylene adipamide (Nylon 66), polyhexamethylene sebacamide (Nylon 610), polyhexamethylene dodecamide (Nylon 612), polyoctamethylene adipamide (Nylon 86), polydecamethylene adipamide (Nylon 106), caprolactam/lauryllactam copolymer (Nylon 6/12), caprolactam/ω-aminononanoic acid copolymer (Nylon 6/9), caprolactam/hexamethylene diammonium adipate copolymer (Nylon 6/66), lauryl lactam/hexamethylene diammonium adipate copolymer (Nylon 12/66), ethylene diammonium adipate/hexamethylenediammonium adipate copolymer (Nylon 26/66), caprolactam/hexamethylenediammonium adipate/hexamethylenediammonium sebacate copolymer (Nylon 6/66/610), ethylenediammonium adipate/hexamethylenediammonium adipate/hexamethylenediammonium sebacate copolymer (Nylon 26/66/610), polyhexamethylene isophthalamide (Nylon 6I), polyhexamethylene terephthalamide (Nylon 6T), hexamethylene isophthalamide/hexamethylene terephthalamide copolymer (Nylon 6I/6T), 11-aminoundecaneamide/hexamethylene terephthalamide copolymer, polynonamethylene terephthalamide (Nylon 9T), polydecamethylene terephthalamide (Nylon 10T), polyhexamethylene cyclohexylamide, polynonamethylene cyclohexylamide, and these polyamides modified with an aromatic amine such as methylenebenzylamine and metaxylenediamine. Metaxylylenediammonium adipate is also another example. The polyamide is preferably an aliphatic polyamide, a polyamide mainly made of caproamide, further preferably a polyamide in which 75 mol% or more of the constitutional units of the polyamide are caproamide units. Among these, the polyamide is preferably Nylon 6 in the light of compatibility with EVOH.

As long as the effects of the present invention are not impaired, the layer (B) can contain additives other than EVOH, an oxygen-absorbing resin, a polyamide and a transition metal catalyst. Examples of the other additives include resins other than EVOH, an oxygen-absorbing resin and a polyamide; desiccants; dispersants; plasticizers; stabilizers; surfactants; coloring materials; UV absorbers; antistatic agents; cross-linking agents; metal salts; fillers; and reinforcement agents such as various fibers.

In the light of further improving gas barrier properties after treatment with water vapor or hot water, it is preferable that the layer (B) comprises a layer (B1) and a layer (B2), and a difference in an ethylene unit content between the EVOH contained in the layer (B1) and the EVOH contained in the layer (B2) is 3 mol% or more. The difference in an ethylene unit content is more preferably 5 mol% or more, further preferably 10 mol% or more. Meanwhile, the difference in an ethylene unit content is preferably 35 mol% or less, more preferably 25 mol% or less, further preferably 20 mol% or less, particularly preferably 15 mol% or less.

The multilayer structure of the present invention comprises a sealant layer (C). The layer (C) is preferably an inner layer of the multilayer structure. The layer (C) preferably contains a thermoplastic resin other than EVOH as a main component. Specific examples of the thermoplastic resin contained in the layer (C) as a main component include polypropylenes; polyethylenes such as low-density polyethylenes, medium-density polyethylenes, high-density polyethylenes, straight-chain low-density polyethylenes; ethylene-vinyl acetate copolymers; ethylene-α-olefin copolymers such as ethylene-propylene copolymers; polybutenes; polymethylpentenes; and ionomers.

A content of the thermoplastic resin contained in the layer (C) as a main component is generally 50 % by mass or more, preferably 60 % by mass or more.

A melt flow rate (MFR, 230° C., under a load of 2160 g) of the thermoplastic resin contained in the layer (C) as a main component is generally 0.1 to 20 g/10 min.

In the light of further improving heat sealability, the thermoplastic resin contained in the layer (C) as a main component preferably has a melting point of 100 to 250° C. The melting point is more preferably 110° C. or higher, further preferably 120° C. or higher. Meanwhile, the melting point is more preferably 200° C. or lower, further preferably 170° C. or lower.

The layer (C) is also preferably made of a biaxially oriented polypropylene from the viewpoint that the EVOH layer can maintain high oxygen barrier properties even after retorting, by reducing the amount of water entering the EVOH layer from the inside of the multilayer structure during retorting.

In the light of further improving recyclability, a polypropylene is preferable as the thermoplastic resin contained in the layer (C) as a main component. A content of the propylene units in the polypropylene is generally 50% by mass or more, preferably 70% by mass or more, more preferably 90% by mass or more, further preferably 95% by mass or more, particularly preferably 98% by mass or more, and most preferably, the polypropylene contains substantially exclusively propylene units.

As long as the effects of the present invention are not impaired, the polypropylene contained in the layer (C) as a main component can contain monomer units other than propylene units. Examples of the other monomer units include units derived from ethylene; and an α-olefin other than propylene such as 1-butene, 1-hexene and 4-methyl-1-pentene.

When the layer (C) contains the polypropylene as a main component, the layer (C) can further contain an ethylene-α-olefin copolymer. The ethylene-α-olefin copolymer can be selected from those contained in the layer (A) as described above. A content of the ethylene-α-olefin copolymer in the layer (C) is preferably 0.1 to 40% by mass.

A multilayer structure of the present invention preferably further comprises a water-vapor barrier layer (D) between the layer (B) and the layer (C). The layer (D) is a deposited aluminum layer or a deposited layer made of an inorganic oxide. The layer (D) is used as an inner layer of the multilayer structure in the light of preventing deterioration of the layer due to its direct contact with a food or hot water.

The layer (D) has shielding properties against oxygen, water vapor and water during retorting. The layer (D), which is used inner than the oxygen barrier layer (B) containing EVOH as a main component in the multilayer structure, can prevent entering of water from the inside of the multilayer structure into an EVOH layer during retorting, so that the multilayer structure of the present invention exhibits excellent gas barrier properties even after retorting. With a thickness of the layer (D) being 1000 nm or less, deposited components can be removed in a short time when the multilayer structure of the present invention is recycled in an aqueous alkaline solution at a high temperature, resulting in excellent economy and energy efficiency during recycling. When the multilayer structure of the present invention is imparted with shading ability, the layer (D) is a deposited aluminum layer. When a content in a package should be visible, the layer (D) is preferably a deposited layer made of an inorganic oxide.

A deposited aluminum layer used for the layer (D) is a layer containing aluminum as a main component. A content of aluminum atoms in the deposited aluminum layer must be 50 mol% or more, preferably 70 mol% or more, more preferably 90 mol% or more, still more preferably 95 mol% or more. A multilayer structure of the present invention can have one or more deposited aluminum layers, and at least one deposited aluminum layer must be placed between the layer (B) containing EVOH as a main component and the sealant layer (C). An average thickness of the deposited aluminum layer is preferably 120 nm or less, more preferably 100 nm or less, even more preferably 90 nm or less. An average thickness of the deposited aluminum layer is preferably 20 nm or more, more preferably 30 nm or more, further preferably 45 nm or more. An average thickness of the deposited aluminum layer can be determined as an average value of the thicknesses at any 10 points of the cross section of the deposited aluminum layer as measured by an electron microscope. In the light of recyclability of the multilayer structure, when the multilayer structure has one or more deposited aluminum layer, the total thickness of the deposited aluminum layers is preferably 1000 nm or less. When the multilayer structure of the present invention has the deposited aluminum layer, a light transmittance at a wavelength of 600 nm can be 10% or less, which means excellent shading performance.

Examples of a deposited layer made of an inorganic oxide used for the layer (D) include vapor deposition layers of an inorganic oxide such as oxides of silicon, aluminum, magnesium, calcium, potassium, tin, sodium, boron, titanium, lead, zirconium and yttrium, preferably alumina or silica. An average thickness of the deposited layer made of an inorganic oxide is preferably 100 nm or less, more preferably 70 nm or less, further preferably 60 nm or less. An average thickness of the deposited layer made of an inorganic oxide is preferably 10 nm or more, more preferably 15 nm or more, further preferably 20 nm or more. An average thickness of the deposited layer made of an inorganic oxide can be determined as an average value of the thicknesses at any 10 points of the cross section of the deposited layer made of an inorganic oxide as measured by an electron microscope. When the multilayer structure of the present invention has a deposited layer made of an inorganic oxide, a light transmittance at a wavelength of 600 nm can be 80% or more, which means excellent visibility of a content as a packaging material. In the light of further improving visibility, a light transmittance at a wavelength of 600 nm is more preferably 90% or more.

A deposited aluminum layer or deposited layer made of a deposited inorganic layer (D) can be deposited by known physical vapor deposition or chemical vapor deposition. Specific examples include vacuum vapor deposition, sputtering, ion plating, ion beam mixing, plasma CVD, laser CVD, MO-CVD and thermal CVD, preferably physical vapor deposition, and among these, particularly preferably vacuum vapor deposition. Here, as long as the effects of the present invention are not impaired, a protective layer (top-coat layer) can be, if necessary, formed over the deposited aluminum layer or the deposited layer made of an inorganic oxide. The upper limit of a surface temperature of a substrate during film deposition is preferably 60° C., more preferably 55° C., further preferably 50° C. The lower limit of a surface temperature of a substrate during film deposition is preferably, but not limited to, 0° C., more preferably 10° C., further preferably 20° C. Before the film deposition, the surface of the substrate can be plasma-treated. The plasma treatment can be a known method, preferably atmospheric pressure plasma treatment. In the atmospheric pressure plasma treatment, a discharge gas used is nitrogen, helium, neon, argon, krypton, xenon, radon or the like. Among these, nitrogen, helium, and argon are preferably used, and nitrogen is particularly preferable because a cost can be reduced. In vapor deposition, a substrate used is a smooth film made of a thermoplastic resin having a melting point of 240° C. or lower, and in the light of smoothness of the vapor deposition film, it is preferable to use a non-oriented polypropylene film, a biaxially oriented polypropylene film, and a biaxially oriented EVOH film. It is also preferable that the non-oriented polypropylene film and the biaxially oriented polypropylene film are multilayer films.

In the light of improving interlayer adhesion, it is also preferred that the multilayer structure has an adhesive layer (Tie) between the layer (B) and another layer such as the layer (A) and the layer (C). The adhesive layer (Tie) can be a resin capable of making the layer (B) and the other layer adhering to each other; for example, a carboxylic acid-modified polyolefin. A carboxylic acid-modified polyolefin is a modified olefin having a carboxyl group obtained by chemically bonding an ethylenically unsaturated carboxylic acid or an anhydride thereof to a polyolefin (for example, by an addition reaction or graft reaction). Examples of a polyolefin include polyolefins such as polyethylenes (low, medium, and high pressure), linear low-density polyethylenes, polypropylenes, and polybutenes; and copolymers of an olefin with a comonomer capable of copolymerizing with the olefin (for example, a vinyl ester and an unsaturated carboxylic acid ester) such as ethylene-vinyl acetate copolymers and ethylene-ethyl acrylate copolymers. Examples of an ethylenically unsaturated carboxylic acid or an anhydride thereof include ethylenically unsaturated monocarboxylic acid and esters thereof, ethylenically unsaturated dicarboxylic acids and monoesters or diesters thereof, or anhydrides thereof, particularly preferably ethylenically unsaturated dicarboxylic anhydrides. Specific examples include maleic acid, fumaric acid, itaconic acid, maleic anhydride, itaconic anhydride, maleic acid monomethyl ester, maleic acid monoethyl ester, maleic acid diethyl ester and fumaric acid monomethyl ester, particularly preferably maleic anhydride.

In the case of bonding the layer (B) to another layer by dry lamination, an adhesive layer can be formed using a general-purpose adhesive for dry lamination.

In the multilayer structure of the present invention, the layer (A), the layer (B) and the layer (C) must be laminated in this sequence. Specific layer configurations of the multilayer structure can be as follows. Here, the left end of each configuration is the outer layer while the right end is the inner layer.
Three layers: A/B/C
Four layers: A/D/B/C, A/B/D/C
Five layers: A/D/B/D/C
Six layers: A/D/B1/B2/D/C

In the multilayer structure of the present invention, it is also preferred that the layer (A), the layer (B), the layer (D) and the layer (C) are laminated in this sequence. Specific layer configurations of the multilayer structure can be as follows. Here, the left end of each configuration is the outer layer while the right end is the inner layer.
Four layers: A/B/D/C
Five layers: A/Tie/B/D/C, A/B/D/Tie/C
Six layers: A/Tie/B/Tie/D/C, A/Tie/B/D/Tie/C

In addition to the above configurations, a printed layer may be formed between these layers.

Examples of a method for producing a multilayer structure of the present invention include, but not limited to, lamination such as dry lamination; co-injection molding; and co-extrusion molding. Examples of a co-extrusion molding include co-extrusion lamination, co-extrusion sheet molding, co-extrusion inflation molding, and co-extrusion blow molding. These methods can be optionally combined.

From an economic standpoint, it is preferable to recover and reuse, for example, scraps such as trims and defective molding products generated during molding the multilayer structure. Therefore, the above multilayer structure can further have a layer made of a recovered composition (hereinafter sometimes abbreviated as a “recovered composition layer”) obtained by melt-kneading such recovered materials of the multilayer structure. In this case, the layer configuration can be, among the aforementioned exemplary layer configurations of the multilayer structure, the configuration in which the recovered composition layer is added at a position adjacent to the layer (A) or the layer (C). The recovered multilayer structure can be that which contains the thermoplastic resin described above as that contained in the layer (C), and can be the multilayer structure of the present invention described above.

The above recovered composition may be obtained by melt-kneading the recovered multilayer structure and an unused resin. Examples of the unused resin include the thermoplastic resins described above as contained in the layer (C). A content of EVOH in the recovered composition is generally 20% by mass or less. It is also preferable to dissolve and remove aluminum or a metal component in a deposited inorganic layer in a hot aqueous alkali solution during recovery of the multilayer structure.

It is preferable that all resin components contained in all layers of the multilayer structure of the present invention have a melting point of 240° C. or lower, or are amorphous. Here, it is more preferable that the multilayer structure further comprises the layer (D) between the layer (B) and layer (C). For example, when the multilayer structure comprises a polyethylene terephthalate (PET) film having a melting point of 250° C. or higher, it is not adequately plasticized during recycling by melt-kneading, and thus it remains as a foreign substance in a product produced using the recovered resin as a raw material, possibly resulting in deterioration in transparency and an appearance. More specifically, a content of the resin components having a melting point of 240° C. or higher in all layers of the multilayer structure of the present invention is 1% by mass or less, preferably 0.5% by mass or less, more preferably 0.1% by mass or less.

The multilayer structure of the present invention can comprise a printed layer. The printed layer can be contained at any position in the multilayer structure of the present invention, and is preferably located on at least one surface of the layer (A). An example of the printed layer is a film obtained by applying a solution containing a pigment or dye and, if necessary, a binder resin, and then drying the film. Examples of a method for applying a printed layer include various coating methods using a wire bar, a spin coater, a die coater, or the like, in addition to a gravure printing method. A thickness of the printed layer is, but not limited to, preferably 0.5 to 10 µm, more preferably 1 to 4 µm.

A total thickness of the multilayer structure of the present invention is, but not limited to, preferably 10 to 200 µm, further preferably 50 to 200 µm. With the total thickness being within the above range, the multilayer structure is moderately hard, so that processability of the multilayer structure during molding is improved. There are no particular restrictions to a thickness of each layer in the multilayer structure, and in the light of moldability, cost and so on, a ratio of the total thickness of the layer (B) to the total thickness of the multilayer structure is preferably 2 to 20 %.

A recovery method comprising melt-kneading the multilayer structure is also a suitable embodiment of the present invention. The resin composition obtained by the method is less colored and exhibits excellent transparency, so that it can be reused in, for example, production of a multilayer structure. A b value of a resin composition obtained by melt-kneading the multilayer structure is preferably 10 or less, more preferably 8 or less, further preferably 6 or less.

A multilayer structure of the present invention exhibits not only high gas barrier properties even after treatment with water vapor or hot water, but also excellent recyclability, and is, therefore, used for various applications such as foods, pharmaceuticals, and infusion bags. Specifically, the multilayer structure is suitably as a material for a packaging container, a packaging film, a deep-drawn container, a cup container, a bottle and the like. A packaging container made of the multilayer structure is a suitable embodiment of the present invention. Examples of the packaging container include pouches such as a stand-up pouch, a pouch with a spout, a pouch with a chuck seal, a flat pouch, and a horizontal bag-filling seal pouch; and a lid for a deep drawn cup container, preferably pouches, more preferably a stand-up pouch. The packaging container is particularly preferably used for sterilization treatment with water vapor or hot water.

A package product, wherein a content is filled in the packaging container of the present invention is a suitable embodiment of the packaging container. Examples of a content filled in the container include, but not limited to, foods, beverages and pharmaceuticals.

A sterilization treatment method comprising sterilizing the package product with water vapor or hot water at 70° C. or higher and 140° C. or lower is a suitable embodiment of the package product. The sterilization treatment specifically includes retorting and boiling treatment. A temperature during retorting is preferably 105° C. or higher and 140° C. or lower, and a treatment time is preferably 5 to 120 min. The retorting can be conducted under an elevated pressure of 0.15 to 0.3 MPa. A retort processing equipment includes a steam type that utilizes hot steam and a hot water immersion type that utilizes pressurized superheated water, and these are used according to the sterilization conditions of the contents such as foods. In addition to a usual retorting process comprising heating to a predetermined temperature and pressurizing, steam retorting, water cascade retorting, microwave retorting, and the like can be also employed. Boiling treatment is a method for sterilizing a content such as foods with hot water for preservation, in which depending on the content, a package product where a content is filled in the packaging container is sterilization-treated at 70 to 100° C. under the atmospheric pressure for 10 to 120 min. Boiling treatment is usually carried out using a hot water tank, in a batch style where the product is immersed in a hot water tank at a certain temperature and then removed after a certain time, or a continuous style where the product is passed through a tunnel-like hot water tank for sterilization.

Even after such a sterilization process, the packaging container has excellent gas barrier properties, allowing for preventing quality of a content such as foods and pharmaceuticals from being deteriorated over a long period of time.

### EXAMPLES

The present invention will be further detailed with reference to, but not limited to, Examples.

### Measurement of a Melting Point and a Fusion Enthalpy of a Resin

Using a differential scanning calorimeter (“Type TA Q2000” from Instruments, Inc.), a polyolefin resin composition (a) was heated to 240° C. at a temperature elevation rate of 10° C./min, quickly cooled it to 0° C. at -50° C./min, kept the temperature for 3 min, and then again heated at a temperature elevation rate of 10° C./min, where a peak-top temperature at an endothermic peak during temperature elevation was determined as a melting point of the main component polyolefin, and a fusion enthalpy of the main component polyolefin was determined from an area of the endothermic peak. When there were two or more endothermic peaks whose peak top temperature was 130° C. or higher, a peak top temperature of the endothermic peak at the highest temperature was determined as a melting point of the main component polyolefin, and a fusion enthalpy of the main component polyolefin was determined from the sum of areas of all endothermic peaks whose peak top temperature was 130° C. or higher. A melting point of a raw material resin was determined as described above.

### 2 Measurement of a Water Vapor Transmission Rate WVTR of a Layer (A) Made of a Polyolefin Resin Composition (a)

A water vapor transmission rate of a monolayer film used for forming a layer (A) of a multilayer structure of each of Examples and Comparative Examples was determined as described below. When a layer (A) and other layers were simultaneously formed by co-extrusion or stretching after co-extrusion during making the multilayer structure, a monolayer film was formed by extrusion and stretching under the same conditions except that only layer (A) was formed, and a water vapor transmission rate of the monolayer film was measured.
Measurement for a film having a water vapor transmission rate of less than 100 g/m²•day

A monolayer film was attached to a water-vapor transmission rate analyzer (“MOCON PERMATRAN W3/33” from Modern Controls, Inc.), and the water-vapor transmission rate was measured by an equal-pressure method under the following conditions.
Measurement temperature: 40° C.
Humidity on the water vapor supply side: 90 %RH
Humidity on the carrier gas side: 0 %RH
   Measurement of a film with a water vapor transmission rate of 100 g/m²•day or more

A 50-cc volume metal cup was filled with granular calcium chloride vacuum-dried at 120° C., and a monolayer film was attached via an adhesive to the cup’s lid surface. After measuring a mass of the cup, a mass of the cup was measured after storage in a thermohygrostat at 40° C. and a humidity of 90 %RH for 24 hours, and a water vapor transmission rate was calculated from a surface area of the lid surface and increase in a mass of the cup.

### Measurement of a Density of a Layer (A) Made of a Polyolefin Resin Composition (a)

A density of a monolayer film (the monolayer film as described in (2)) constituting a layer (A) of a multilayer structure of each of Examples and Comparative Examples was determined at 23° C. using a dry automatic pycnometer (Accupyc II 1340, Shimadzu Corporation).

### ¹H NMR Measurement of a Polyolefin Resin

A polyolefin resin was dissolved in 1,2-dichlorobenzene-d4 (deuterated solvent), and was subjected to composition analysis at 130° C. by a ¹H NMR equipment (Nuclear magnetic resonance apparatus from JEOL Ltd., 400 MHz, TMS as a reference peak). When a polyolefin resin used for a layer (A) contains a polypropylene as a main component, an integral ratio of an integral value of chemical shift at 1.25 ppm to 1.50 ppm to an integral value of chemical shift (TMS reference) at 1.62 ppm to 1.78 ppm in a ¹H NMR spectrum was calculated.

### Evaluation of Heat Sealability of a Pouch

Ten pouches produced in each of Examples and Comparative Examples were filled with 80 g of ion-exchange water, and water leakage and shape retainability as an index of heat sealability were evaluated in accordance with the following criteria.
Water leakage
   A: No water leakage in any of the 10 pouches
   B: Water leakage in some of the 10 pouches
Shape retainability
   A: The resin did not fuse to the seal bar, and pouches could be continuously made.
   B: The resin fused to some part of the seal bar, and pouches could not be continuously made.

### Measurement of an Oxygen Concentration of a Pouch Before and After Retorting

To the inner surface of a pouch produced in each of Examples and Comparative Examples (the inner surface of a reference multilayer film side including “KURARISTER C” for the pouches of Examples 17 to 37 and Comparative Examples 8 to 20) was adhered an oxygen concentration sensor chip (a portable non-destructive oxygen analyzer “Fibox4 trace” from PreSens, a measurement chip: SP-PSt3-YAU-D5-YOP) via an adhesive, and after drying at 20° C. for 15 hours, 80 g of ion-exchange water whose dissolved oxygen concentration was reduced to 2.0 ppm by nitrogen bubbling was charged and the opening was sealed by heat sealing, to produce a pouch containing deoxygenated water. The pouch was stored at 20° C. for 2 hours, and then a dissolved oxygen concentration in the pouch was measured as a dissolved oxygen concentration before retorting.

Next, using a high pressure retort sterilizer (Hisaka Works, Ltd.), retorting was conducted in hot water under the conditions of a temperature of 120° C. and a gauge pressure of 0.17 MPa for 30 min. In Examples 1 to 16 and Comparative Examples 1 to 7, attached water on the surface of a pouch was wiped off after retorting, and the pouch was stored in a thermostatic chamber at a temperature of 20° C. and a humidity of 65 % for one week, and then a dissolved oxygen concentration of water in the pouch after retorting was measured as a dissolved oxygen concentration after retorting. In Examples 17 to 37 and Comparative Examples 8 to 20, attached water on the surface of a pouch was wiped off after retorting, and the pouch was stored in a thermostatic chamber at a temperature of 20° C. and a humidity 65 % for 6 months, and a dissolved oxygen concentration of water in the pouch after retorting was measured after 1 month and 6 months, as a dissolved oxygen concentration after retorting.

### Evaluation of Recyclability

Forty grams of a cut piece of a pouch produced in each of Examples 1 to 16 and Comparative Examples 1 to 7 was put into a biaxial kneader mixer (Toyo Seiki Seisaku-sho, Ltd., “Labo Plastomill R-60”), and melt-kneaded at 230° C. and 100 rpm for 5 minutes under a nitrogen atmosphere. Subsequently, the molten resin was removed and sandwiched between two steel plates at 20° C. to produce a circular flat plate with a thickness of 4 mm. A resin color (b value) of the flat plate was determined using a colorimetric color-difference meter “ZE-2000” from Nippon Denshoku Industries Co., Ltd. in accordance with ASTM-D2244 (color scale system 2). It is judged that the smaller the b value is, the less coloration is, the higher transparency is, and the better recyclability is.

### Evaluation of Recyclability by Treatment With an Aqueous Alkaline Solution

A multilayer film used in each of Examples 17 to 37 and Comparative Examples 8 to 20 was cut into 1 cm squares. Then, five pieces of the cut film and a magnetic stirrer tip were added to a 200 mL volume conical flask filled with 100 mL of 1 mol/L aqueous sodium hydroxide solution. A reflux condenser was attached and then the flask was heated to 80° C. with stirring. A film strip was removed from the flask every 10 minutes, rinsed with water, wiped off water, and then a light transmittance at a wavelength of 600 nm was determined using a UV-Vis spectrophotometer (“UV-2540” from Shimadzu Corporation), and a time until a light transmittance reached 60 % or more was measured and evaluated in accordance with the following criteria. When a film strip was peeled, the measurement was made by overlapping two or more film strips with water being wiped off. It is judged that the shorter the time taken until a light transmittance of a film strip reaches 60 % or more is, the better recyclability by treatment with the aqueous alkaline solution is.
A: less than 10 min
B: 10 min or more and less than 30 min
C: 30 min or more (with metallic luster)

### Evaluation of a Resin Color After Recycling

A multilayer film having a layer (A), a layer (B), a layer (D) and a layer (C) in this sequence made in each of Examples 17 to 37 and Comparative Examples 8 to 20 was cut into 1 cm square pieces, and 50 g of the cut film pieces and a magnetic stirrer tip were added to a 2 L conical flask filled with 1 L of 1 mol/L aqueous sodium hydroxide solution. A reflux condenser was attached and then the flask was heated to 80° C. with stirring for 1 hour. After cooling to 25° C., the film pieces were filtered through a metal mesh with an aperture of 2 mm. Washing the film pieces with 2 L of ion-exchanged water was repeated three times, and the film pieces were dried in a hot-air drier at 80° C. for 12 hours. 40 g of the obtained film strips was put into a biaxial kneader mixer (Toyo Seiki Seisaku-sho, Ltd., “Labo Plastomill R-60”), and melt-kneaded at 230° C. and 100 rpm for 5 minutes under a nitrogen atmosphere. Subsequently, the molten resin was removed and sandwiched between two steel plates at 20° C. to shape a circular flat plate with a thickness of 4 mm. A resin color (b value) of the flat plate was determined using a colorimetric color-difference meter “ZE-2000” from Nippon Denshoku Industries Co., Ltd. in accordance with ASTM-D2244 (color scale system 2). It is judged that the smaller the b value is, the less coloration is, and the better recyclability is.

### Evaluation of Fish Eyes in a Recycled Resin

The flat plate resin produced in (9) was cut into cubes of 2 mm on each side, and 5 parts by mass of the cut resin was dry-blended with 95 parts by mass of a polypropylene resin PP-1 (“NOVATEC EG7FTB” from Japan Polypropylene Corporation, melting point: 149° C., MFR (temperature: 230° C., load: 2160 g): 1.3 g/10 min). It was then melt-kneaded under the conditions of a cylinder temperature of 230° C. and a screw rotation speed of 100 rpm by a biaxial kneading extruder (screw diameter: 25 mmφ, L/D=30, from Toyo Seiki Seisaku-sho, Ltd.), and was then extruded as strands into a 5° C. cooling water tank through a die, pelletized by a strand cutter to give recycled pellets. The resulting recycled pellets were fed into a monolayer extruder (screw diameter: 20 mmφ, L/D=20, from Toyo Seiki Seisaku-sho, Ltd.), melt-kneaded at a cylinder temperature of 230° C. and a screw rotation speed of 40 rpm, and cast from a die onto a cooling roll at 50° C. to produce a recycled film having a thickness of 20 µm. The recycled film was subjected to measurement for the number of fish eyes with a size of 50 µm or more and the presence of metallic foreign matters by a defect detector and a metal detector. The number of fish eyes was measured for every 0.1 m², and evaluated by the following four levels.
A: less than 100 fish eyes, and no metallic foreign matters
B: 100 or more and 1000 or less fish eyes, and no metallic foreign matters
C: 1000 or more fish eyes, and no metallic foreign matters
D: metallic foreign matters were detected.

### Measurement of a Thickness of a Deposited Layer

A thickness of a deposited layer used in each of Example 1 to 16 and Comparative Example 1 to 7 was measured using an ultra-high resolution scanning electron microscope SU8010 (Hitachi High-Tech Corporation). Specifically, each deposited film was ion-polished by argon irradiation to give a sample for film cross-section measurement, which was then observed under an acceleration voltage of 1 kV, a magnification of 100,000x, and a reflected electron image (BSE) mode. A thickness of the deposited layer was measured at 10 points at 100 nm intervals, and an average of these measurements was used as a thickness of the deposited layer.

### Example 1

### (Production of a Coextruded Film)

For a layer (B), pellets of EVOH-1 (“EVAL” E171B from Kuraray Co., Ltd., ethylene unit content: 44 mol%, saponification degree: 99.9 mol%, MFR (temperature: 190° C., load: 2160 g): 1 g/10 min, melting point: 165° C.) were used. For a layer (C), a polypropylene resin PP-4 (“NOVATEC PP EA7AD” from Japan Polypropylene Corporation, melting point 159° C., propylene unit content: 99.2 % by mass, ethylene unit content: 0.8 % by mass) was used. As an adhesive resin Tie-1, “Admer QF500, melting point 161° C.” from Mitsui Chemicals, Inc. was used. Into each of three-material three-layer multilayer extruders were fed EVOH-1, Tie-1 and PP-4, and layers of the resins were cast under the conditions of an extrusion temperature of 210 to 230° C. and a die temperature of 230° C. such that through the die to a cooling roll at 80° C., PP-4 was in contact with the cooling roll, to produce a three-material three-layer coextruded film having the layer (B) and the layer (C), with a layer configuration of B (EVOH-1, 20 µm)/Tie-1 (10 µm)/C (PP-4, 100 µm).

### (Production of a Multilayer Film)

A layer (A) was polymethylpentene film (“FORWRAP” from Riken fabro Corporation, thickness: 10 µm, WVTR = 360 g/m²•day, melting point: 227° C., polymethylpentene content: 99 % by mass or more, 4-methyl-1-pentene unit content in polymethylpentene: 80 % by mass or more). One side of the film was corona-treated, and to the corona-treated side was applied a 2-component adhesive for dry laminate Tie-2 (“Takelac A520/Takenate A50” from Mitsui Chemicals, Inc., a mixture of 60 parts by mass of Takelac A520 and 10 parts by mass of Takenate A50 in 100 parts by mass of ethyl acetate, amorphous after curing) by a bar coater such that a thickness after drying was to be 2 µm, and it was dried in an oven at 80° C. for 3 minutes. Subsequently, in a hot laminator at a roll temperature of 70° C., the adhesive Tie-2 applied side of the polymethylpentene film and the layer (B) side of the above coextruded film were laminated to obtain a multilayer film having the layer (A), the layer (B), and the layer (C). The layer configuration of the multilayer film is shown in Table 1.

### (Production of a Pouch)

The multilayer film obtained was stored in a thermostatic chamber at 40° C. for 3 days to cure the adhesive. Then, the multilayer film was cut into two 11 cm square pieces, which were overlapped such that the layers (C) were in contact with each other. Then, each of the three sides of the multilayer film was heat-sealed at 0.5 cm width for 3 sec by a hot-plate sealer heated to 160° C., to produce 10 bags (pouches) of the multilayer film, which were evaluated in accordance with (5) to (7).

Table 1 shows the evaluation results of (1) to (3), and (5) to (7).

### Example 2

### (Production of a Coextruded Film)

Into each of four-material four-layer multilayer extruders were fed EVOH-1, EVOH-2 (“EVAL” L171B from Kuraray Co., Ltd., ethylene unit content: 27 mol%, saponification degree: 99.9 mol%, MFR (temperature: 190° C., load: 2160 g): 1 g/10 min, melting point: 190° C.), an adhesive resin Tie-1 and a polypropylene resin PP-4, and layers of the resins were cast under the conditions of an extrusion temperature of 210 to 230° C. and a die temperature of 230° C. such that through the die to a cooling roll at 80° C., PP-4 was in contact with the cooling roll, to produce a four-material four-layer coextruded film having the layer (B1), the layer (B2) and the layer (C), with a layer configuration of B1 (EVOH-1, 10 µm)/B2 (EVOH-2, 10 µm)/adhesive resin (10 µm)/C (PP-4, 100 µm). A multilayer film and pouchs were produced as described in Example 1, substituting the coextruded film obtained for the three-material three-layer coextruded film, and various evaluations were performed. The results are shown in Table 1.

### Example 3

### (Production of an Oxygen-Absorbable Oxygen Barrier Resin EVOH-3)

92 parts by mass of EVOH (“EVAL” F101B from Kuraray Co., Ltd., ethylene unit content: 32 mol%, saponification degree: 99.9 mol%, MFR (temperature: 190° C., load: 2160 g): 1 g/10 min, melting point: 183° C.) was mixed with 8 parts by mass of a polyoctenylene (“VESTENAMER 8020” from Evonik Industries, melting point: 54° C.) and 0.2 parts by mass of cobalt stearate, and the mixture was melt-kneaded by a biaxial kneading extruder (screw diameter: 25 mmφ, L/D=30, from Toyo Seiki Seisaku-sho, Ltd.) under the conditions of a cylinder temperature of 230° C. and a screw rotation speed of 100 rpm, and was then extruded from a die into a cooling water tank at 5° C. as a strand, which was then pelletized by a strand cutter, to give pellets of an oxygen-absorbable oxygen barrier resin EVOH-3 (MFR (temperature: 190° C., load: 2160 g): 1 g/10 min). The EVOH-3 pellets were fed to a monolayer extruder (screw diameter: 20 mmφ, L/D=20, Toyo Seiki Seisaku-sho, Ltd.), and melt-knead under the conditions of a cylinder temperature of 210° C. and a screw rotation speed of 40 rpm, and cast from a die to a cooling roll at 50° C., to give a monolayer film of EVOH-3 with a thickness of 20 µm. Then, the monolayer film of EVOH-3 was cut into a 100 mg sample, which was placed in a 35.5 mL inner-volume pressure-proof glass bottle in the air, and further added a sample bottle filled with 1 mL of water. The glass bottle was sealed by an aluminum cap with a NAFLON-rubber packing, and stored under the conditions of 60° C. and 100 %RH for 7 days. An oxygen concentration in the vessel after storage was measured by PACKMASTER (lijima Electronics Corporation), and oxygen absorbability of EVOH-3 was evaluated from oxygen content change in the vessel. An oxygen absorption of EVOH-3 was 36 cc/g.

A multilayer film and a pouch were produced as described in Example 2, substituting EVOH-3 for EVOH-2 in production of a coextruded film, and various evaluations were performed. The results are shown in Table 1.

### Example 4

### (Washing of an EPDM Elastomer)

To a 5 L separable flask were added 100 parts by mass of an EPDM elastomer (“NORDEL IP4725P” from The Dow Chemical Company, Mw=135,000, MFR (temperature: 190° C., load: 2160 g) =0.45 g/10 min) produced by copolymerizing ethylene, propylene and 5-ethylidene-2-norbornene, and 200 parts by mass of acetone. The flask was immersed in a water bath at 50° C., and the mixture was heated with stirring for 10 hours. After removing acetone, the EPDM elastomer was dried in vacuo at 40° C. for one day. Thus, additives contained in the EPDM elastomer was removed by extraction.

### (Production of an Oxygen Barrier Resin EVOH-4)

90 parts by mass of EVOH (“EVAL” F101B from Kuraray Co., Ltd., ethylene unit content: 32 mol%, saponification degree: 99.9 mol%, MFR (temperature: 190° C., load: 2160 g): 1 g/10 min, melting point: 183° C.) was mixed with 10 parts by mass of EPDM (ethylene-propylene-5-ethylidene-2-norbornene copolymer, melting point: 70° C.) elastomer washed as described above, 0.2 parts by mass of cobalt stearate and 0.7 parts by mass of magnesium stearate. The mixture was melt-kneaded by a biaxial kneading extruder (screw diameter: 25 mmφ, L/D=30, from Toyo Seiki Seisaku-sho, Ltd.) under the conditions of a cylinder temperature of 230° C., a screw rotation speed of 100 rpm, and then from a die, extruded into a cooling water tank at 5° C. as a strand, which was then pelletized by a strand cutter, to afford pellets of an oxygen-absorbable oxygen barrier resin EVOH-4. A monolayer film of EVOH-4 with a thickness of 20 µm was formed as described in Example 3, and an oxygen absorption was evaluated. An oxygen absorption of EVOH-4 was 20 cc/g.

### (Production of a Multilayer Film)

A multilayer film and a pouch were produced as described in Example 2, substituting the pellets of EVOH-4 obtained for EVOH-2 in production of a coextruded film, and various evaluations were performed. The results are shown in Table 1.

### Example 5

### (Production of a Polyolefin Film)

Pellets of a polymethylpentene (“MX002O” from Mitsui Chemicals, Inc., melting point: 227° C., MFR (temperature: 260° C., load: 5000 g): 21 g/10 min, 4-methyl-1-pentene unit content: 80 % by mass or more) were fed into a monolayer extruder(screw diameter: 20 mmφ, L/D=20, from Toyo Seiki Seisaku-sho, Ltd.), and melt-kneaded under the conditions of a cylinder temperature of 260° C. and a screw rotation speed of 40 rpm, and cast through a die to a cooling roll at 50° C., to give a polymethylpentene film with a thickness of 100 µm. Subsequently, one side of the obtained polymethylpentene film was corona-treated.

A multilayer film and a pouch were produced as described in Example 3, except that the polymethylpentene film obtained was used as a layer (A), and various evaluations were performed. The results are shown in Table 1. A dissolved oxygen concentration in water in the pouch one week after retorting was equal to that in Example 3 as shown in Table 1. Meanwhile, a dissolved oxygen concentration 3 days after retorting was 1.5 ppm in Example 3, while being 1.9 ppm in this example, Example 5. Thus, when an elapsed time after retorting was short, Example 3, which has a higher water vapor transmission rate of the layer (A), showed a lower dissolved oxygen concentration.

### Example 6

### (Production of a Biaxially Oriented Polymethylpentene Film)

The polymethylpentene film with a thickness of 100 µm produced in Example 5 was cut into a 10 cm square piece, which was subjected to simultaneous biaxial stretching 3 times in a longitudinal direction and 3 times in a transverse direction using a biaxial stretching machine under the following conditions.
Preheating temperature: 180° C.
Preheating time: 1.5 min
Stretching speed: 1 m/min
Heat setting temperature: 180° C.
Heat setting time: 1 min

Subsequently, one side of the obtained biaxially oriented polymethylpentene film (thickness: 10 µm) was corona-treated.

A multilayer film and a pouch were produced as described in Example 3, except that the biaxially oriented polymethylpentene film obtained was used as a layer (A), and various evaluations were performed. The results are shown in Table 1.

### Example 7

A multilayer film and a pouch were produced as described in Example 3, except that a biaxially oriented polypropylene film (“PORO-FL2” from Futamura Chemical Co., Ltd., thickness: 20 µm, WVTR=21 g/m²·day, melting point_{:} 160° C., polypropylene content: 75 % by mass or more, propylene unit content in the polypropylene: 98 % by mass or more) was used as a layer (A), and various evaluations were performed. Furthermore, measurement in (4) was performed using the biaxially oriented polypropylene film. The results are shown in Table 1.

### Example 8

### (Production of a Polyolefin Resin)

70 parts by mass of a random polypropylene resin PP-1 (“NOVATEC EG7FTB” from Japan Polypropylene Corporation, MFR (temperature: 230° C., load: 2160 g): 1.3 g/10 min, ethylene unit content: 2.2 % by mass, propylene unit content: 97.8 % by mass, melting point: 149° C.) was mixed with 30 parts by mass of an ethylene-propylene copolymer (“Tafmer P-0375” from Mitsui Chemicals, Inc., MFR (temperature: 190° C., load: 2160 g) =1.8 g/10 min, ethylene unit content: 70 % by mass, propylene unit content: 30 % by mass, density: 0.859 g/cm³, melting point: 28° C.), and the mixture was melt-kneaded by a biaxial kneading extruder (screw diameter: 25 mmφ, L/D=30, from Toyo Seiki Seisaku-sho, Ltd.) under the conditions of a cylinder temperature of 230° C. and a screw rotation speed of 100 rpm, and extruded from a die to a cooling water tank at 5° C. as a strand, which was then pelletized by a strand cutter to give polyolefin resin pellets having a melting point of 149° C.

### (Production of a Biaxially Oriented Polyolefin Film)

The obtained pellets of the polyolefin resin were fed to a monolayer extruder (screw diameter: 20 mmφ, L/D=20, from Toyo Seiki Seisaku-sho, Ltd.), and melt-kneaded under the conditions of a cylinder temperature of 230° C. and a screw rotation speed of 40 rpm, and cast through a die to a cooling roll at 80° C., to give a film with a thickness of 100 µm. The obtained film was cut into a 10 cm square piece, which was then subjected to simultaneous biaxial stretching 3.5 times in a longitudinal direction and 3.5 times in a transverse direction using a biaxial stretching machine under the following conditions, to give a biaxially oriented polypropylene film with a thickness of 8 µm.
Preheating temperature: 140° C.
Preheating time: 1.5 min
Stretching speed: 1 m/min
Heat setting temperature: 140° C.
Heat setting time: 1 min

Subsequently, one side of the obtained biaxially oriented polypropylene film (thickness: 8 µm) was corona-treated.

A multilayer film and a pouch were produced as described in Example 7, except that the biaxially oriented polypropylene film obtained (thickness: 8 µm, WVTR=63 g/m²·day, melting point: 149° C.) was used as a layer (A), and various evaluations were performed. The results are shown in Table 1.

### Example 9

### (Production of an Unstretched Polyolefin Film)

A multilayer film and a pouch were produced as described in Example 7, except that an unstretched polypropylene film (“GLC” from Mitsui Chemicals Tohcello, Inc., thickness: 18 µm, WVTR=30 g/m²·day, melting point_{:} 163° C., polypropylene content: 80 % by mass or more, propylene unit content in the polypropylene: 98 % by mass or more) was used as a layer (A), and various evaluations were performed. The results are shown in Table 1.

### Example 10

### (Production of an Unstretched Polyolefin Film)

Pellets of a random polypropylene resin PP-1 were fed into a monolayer extruder (screw diameter: 20 mmφ, L/D=20, from Toyo Seiki Seisaku-sho, Ltd.), and melt-kneaded under the conditions of a cylinder temperature of 230° C. and a screw rotation speed of 10 rpm, and cast through a die to a cooling roll at 80° C., to give an unstretched polypropylene film with a thickness of 10 µm.

A multilayer film and a pouch were produced as described in Example 7, except that the obtained unstretched polypropylene film (thickness 10 µm, WVTR=28 g/m²·day, melting point_{:} 149° C., polypropylene content: 100 % by mass, propylene unit content in the polypropylene: 97.8 % by mass, an ethylene unit content: 2.2 % by mass) was used as a layer (A), and various evaluations were performed. The results are shown in Table 1.

### Example 11

### (Production of a Porous Polyolefin Film)

A biaxially oriented polypropylene film (“Pylen Film-OT P2161” from TOYOBO CO., LTD., thickness: 30 µm, one side corona-treatment, a polypropylene (homopolymer) content: 98 % by mass or more) was processed using an apparatus for manufacturing a microporous plastic film as described in JP 2017-226060A for forming through-holes, to give a porous polypropylene film (thickness: 30 µm) having through-holes. A pore size observed by an optical stereomicroscope was 30 µm to 100 µm, and a proportion of the through-holes per a unit area of the film was 10 to 15%. A WVTR was 2900 g/m²·day.

A multilayer film and a pouch were produced as described in Example 7, except that the porous polypropylene film obtained was used as a layer (A), and various evaluations were performed. The results are shown in Table 1.

### Example 12

### (Production of a Polyolefin Resin)

50 parts by mass of a polymethylpentene (“MX002O” from Mitsui Chemicals, Inc., melting point: 227° C., MFR (temperature: 260° C., load: 5000 g): 21 g/10 min, a 4-methyl-1-pentene unit content: 95 % by mass or more) was mixed with 50 parts by mass of a polymethylpentene (“Absortomer EP-1013” from Mitsui Chemicals, Inc., a 4-methyl-1-pentene unit content: 80 % by mass or more, MFR=10 g/10 min (load: 2.16 kg, 230° C.), melting point: 131° C.), and the mixture was melt-kneaded under the conditions of a cylinder temperature of 240° C. and a screw rotation speed of 100 rpm by a biaxial kneading extruder (screw diameter: 25 mmφ, L/D=30, from Toyo Seiki Seisaku-sho, Ltd.), and then extruded through a die into a cooling water tank at 5° C. as a strand, which was then pelletized by a strand cutter to give pellets of the polyolefin resin PO-1 with a melting point of 225° C. A monolayer film with a thickness of 10 µm was formed from the PO-1 pellets using a single-screw extruder, and a WVTR measured was 80 g/m²·day.

### (Production of an Adhesive Resin)

50 parts by mass of an adhesive resin (“Admer QF500” from Mitsui Chemicals, Inc.) was mixed with 50 parts by mass of an α-olefin copolymer (“Absortomer EP-1013” from Mitsui Chemicals, Inc., MFR=10 g/10 min (load: 2.16 kg, 230° C.), melting point: 131° C.), and melt-knead by a biaxial kneading extruder (screw diameter: 25 mmφ, L/D=30, from Toyo Seiki Seisaku-sho, Ltd.) under the conditions of a cylinder temperature of 230° C. and a screw rotation speed of 100 rpm, and extruded through a die into a cooling water tank at 5° C. as a strand, which was then pelletized by a strand cutter to give pellets of the adhesive resin Tie-3.

### (Production of a Coextruded Film)

Into each extruder of a six-material six-layer multilayer extruder were fed a polyolefin resin PO-1, an adhesive resin Tie-3, EVOH-1, EVOH-3, an adhesive resin Tie-1, and a polypropylene resin PP-4, and layers of the resins were cast under the conditions of an extrusion temperature of 210 to 235° C. and a die temperature of 235° C., such that through the die to a cooling roll at 80° C., PP-4 was in contact with the cooling roll, to give a six-material six-layer coextruded film having the layer (A), the layer (B) and the layer (C). A layer configuration of the coextruded film is shown in Table 2. A pouch made of the coextruded film was produced as described in Example 1, except that the coextruded film obtained was used and various evaluations were performed. The results are shown in Table 2.

### Example 13

### (Production of a Biaxially Oriented Polypropylene Film)

Pellets of a random polypropylene resin PP-1 were fed into a single-screw extruder (screw diameter: 20 mmφ, L/D=20, from Toyo Seiki Seisaku-sho, Ltd.), and melt-kneaded under the conditions of a cylinder temperature of 230° C. and a screw rotation speed of 40 rpm, and cast through a die to a cooling roll at 80° C., to give a film with a thickness of 60 µm. The film obtained was cut into a 10 cm square piece, and subjected to simultaneous biaxial stretching 2.5 times in a longitudinal direction and 2.5 times in a vertical direction using a biaxial stretching machine under the following conditions.
Preheating temperature: 140° C.
Preheating time: 1.5 min
Stretching speed: 1 m/min
Heat setting temperature: 140° C.
Heat setting time: 1 min

A WVTR of the obtained biaxially oriented polypropylene film (thickness: 10 µm) was 32 g/m²·day.

### (Production of a Polyolefin Resin PP-2)

70 parts by mass of a random polypropylene resin PP-1 was mixed with 30 parts by mass of a propylene elastomer (an ethylene-propylene copolymer, “Vistamaxx 6102” from Exxon Mobil Corporation, MFR (temperature: 230° C., load: 2160 g) = 3 g/10 min, ethylene unit content: 16% by mass, propylene unit content: 84% by mass, density: 0.862 g/cm³, melting point: 48° C.), and melt-kneaded by a biaxial kneading extruder (screw diameter: 25 mmφ, L/D=30, from Toyo Seiki Seisaku-sho, Ltd.) under the conditions of a cylinder temperature of 230° C. and a screw rotation speed of 100 rpm, and then extruded through a die into a cooling water tank at 5° C. as a strand, which was then pelletized by a strand cutter to give pellets of a polyolefin resin PP-2 with a melting point of 149° C.

### (Production of a Coextruded Sheet)

Into each extruder of a four-material five-layer multilayer extruder were fed a random polypropylene resin PP-1, an adhesive resin Tie-1, EVOH-1, an adhesive resin Tie-1, and a polyolefin resin PP-2, and layers of the resins were cast under the conditions of an extrusion temperature of 210 to 235° C. and a die temperature of 235° C., such that through the die to a cooling roll at 80° C., the polypropylene resin PP-2 was in contact with the cooling roll, to give a four-material five-layer coextruded sheet having the layer (A), the layer (B) and the layer (C) having a layer configuration of PP-1 (60 µm)/Tie-1 (30 µm)/EVOH-1 (120 µm)/Tie-1 (60 µm)/PP-2 (600 µm).

### (Production of a Co-Oriented Film)

The obtained co-extruded sheet (870 µm) was cut into a 10 cm square piece, which was subjected to simultaneous biaxial stretching 2.5 times in a longitudinal direction and 2.5 times in a vertical direction using a biaxial stretching machine to give a co-oriented film. A layer configuration of the co-oriented film obtained was as described in Table 2.
Preheating temperature: 140° C.
Preheating time: 1.5 min
Stretching speed: 0.1 m/min
Heat setting temperature: 140° C.
Heat setting time: 1 min

### (Production of a Pouch)

The co-oriented film obtained was cut into two 11 cm square pieces, which were overlapped such that the layers (C) were in contact with each other. Then, each of the three sides of the co-oriented extruded film was heat-sealed at 0.5 cm width for 3 sec by a hot-plate sealer heated to 140° C., to produce 10 pouches of the multilayer film, which were evaluated in accordance with (5) to (7). Table 2 shows the evaluation results of (1) to (7).

### Example 14

### (Production of a Co-Oriented Film)

Into each extruder of a five-material six-layer multilayer extruder were fed a random polypropylene resin PP-1, an adhesive resin Tie-1, EVOH-1, EVOH-3, an adhesive resin Tie-1, and a polyolefin resin PP-2, and layers of the resins were cast under the conditions of an extrusion temperature of 210 to 235° C. and a die temperature of 235° C., such that through the die to a cooling roll at 80° C., the polypropylene resin was in contact with the cooling roll, to give a five-material six-layer coextruded sheet having the layer (A), the layer (B) and the layer (C) having a layer configuration of PP-1 (60 µm)/Tie-1 (30 µm)/EVOH-1 (60 µm)/EVOH-3 (60 µm)/ Tie-1 (60 µm)/PP-2 (600 µm). A co-oriented film and pouches were produced as described in Example 13, except that the co-extruded sheet obtained was used. A layer configuration of the co-oriented film obtained and the evaluation results of (1) to (7) are shown in Table 2.

### Example 15

### (Production of a Polyolefin Resin PP-3)

Pellets of a polyolefin resin PP-3 having a melting point of 149° C. were produced as described in Example 13, except that 90 parts by mass of a random polypropylene resin PP-1 was mixed with 10 parts by mass of a propylene elastomer (ethylene-propylene copolymer, “Vistamaxx 6102” from Exxon Mobil Corporation, MFR (temperature: 230° C., load: 2160 g) = 3 g/10 min, ethylene unit content: 16% by mass, propylene unit content: 84% by mass, density: 0.862 g/cm³, melting point: 48° C.).

The pellets of PP-3 were fed into a single-screw extruder (screw diameter: 20 mmφ, L/D=20, from Toyo Seiki Seisaku-sho, Ltd.), and melt-knead under the conditions of a cylinder temperature of 230° C. and a screw rotation speed of 40 rpm, and cast through a die to a cooling roll at 80° C., to give a film with a thickness of 60 µm. The film obtained was cut into a 10 cm square piece, which was then subjected to simultaneous biaxial stretching 2.5 times in a longitudinal direction and 2.5 times in a vertical direction using a biaxial stretching machine under the following conditions.
Preheating temperature: 140° C.
Preheating time: 1.5 min
Stretching speed: 1 m/min
Heat setting temperature: 140° C.
Heat setting time: 1 min

A WVTR of the obtained biaxially oriented polypropylene film (thickness: 10 µm) was 38 g/m²·day.

### (Production of a Co-Oriented Film)

A co-extruded sheet, a co-oriented film, and pouches were produced as described in Example 14, except that instead of PP-1, the pellets of PP-3 were fed into the first extruder, and various evaluations were performed. The results are shown in Table 2.

### Example 16

### (Production of an Oxygen Barrier Resin EVOH-5)

85 parts by mass of EVOH-3 pellets were mixed with 15 parts by mass of Nylon 6 (from UBE Corporation, UBE Nylon 1013A, melting point: 223° C.), and the mixture was melt-kneaded under the conditions of a cylinder temperature of 230° C. and a screw rotation speed of 100 rpm by a biaxial kneading extruder (screw diameter: 25 mmφ, L/D=30, from Toyo Seiki Seisaku-sho, Ltd.), and then extruded through a die into a cooling water tank at 5° C. as a strand, which was then pelletized by a strand cutter to give pellets of an oxygen-absorbable oxygen barrier resin EVOH-5. A monolayer film made of EVOH-5 with a thickness of 20 µm was formed as described in Example 3, and an oxygen absorption thereof was evaluated. An oxygen absorption of EVOH-5 was 30 cc/g.

### (Production of a Co-Oriented Film)

A co-extruded sheet, a co-oriented film and pouches were produced as described in Example 15, substituting EVOH-5 for EVOH-3, and various evaluations were performed. The results are shown in Table 2.

### Comparative Example 1

A multilayer film and pouches were produced as described in Example 1 except that a biaxially oriented polypropylene film (“Pylen Film-OT P2161” from TOYOBO CO., LTD., thickness: 20 µm, one side corona-treated, WVTR=5.6 g/m²·day, melting point: 164° C.) was used as a layer (A), and various evaluations were performed. The results are shown in Table 2.

### Comparative Examples 2 and 3

As a layer (A), a biaxially oriented polypropylene film (“Pylen Film-OT P2161” from TOYOBO CO., LTD., thickness: 20 µm, one side corona-treated, WVTR=5.6 g/m²·day, melting point_{:} 164° C.) was used in Comparative Example 2, and a biaxially oriented Nylon film (“EMBLEM ONBC” from UNITIKA LTD., thickness: 15 µm, both sides corona-treated, WVTR=200 g/m²·day, melting point: 220° C.) was used in Comparative Example 3. Except these points, a multilayer film and pouches were produced as described in Example 3, and various evaluations were performed. The results are shown in Table 2.

### Comparative Example 4

### (Production of a Polyolefin Film)

A monolayer film of a linear low-density polyethylene, LLDPE with a thickness of 10 µm was produced as described in Example 5 except that a polymethylpentene was replaced with LLDPE (“ULTZEX 2022L” from Prime Polymer Co., Ltd., melting point: 120° C., MFR (temperature: 190° C., load: 2160 g): 2 g/10 min) and a cylinder temperature of a monolayer extruder was 210° C.

A multilayer film and pouches were produced as described in Example 3 except that the obtained LLDPE film (thickness: 10 µm, WVTR=50 g/m²·day, melting point: 120° C.) was used as a layer (A), and various evaluations were performed. The results are shown in Table 2.

### Comparative Example 5

### (Production of a Co-Oriented Film)

A co-extruded sheet was produced as described in Example 13, except that in production of a co-extruded sheet, a thickness of PP-1 was changed such that a thickness of the layer (A) in a co-oriented film obtained was to be 30 µm. A co-oriented film and pouches were produced from the co-extruded sheet obtained, and various evaluations were performed. The results are shown in Table 2.

### Comparative Example 6

### (Production of an Oxygen Barrier Resin EVOH-6)

Pellets of an oxygen-absorbable oxygen barrier resin EVOH-6 were produced as described in Example 16, except that 50 parts by mass of EVOH-3 pellets were mixed with 50 parts by mass of Nylon 6 (UBE Corporation, UBE Nylon 1013A).

### (Production of a Co-Oriented Film)

A co-extruded sheet, a co-oriented film and pouches were produced as described in Example 16, except that instead of EVOH-1, pellets of EVOH-6 were fed into the third extruder, and various evaluations were performed. The results are shown in Table 2.

### Comparative Example 7

### (Production of a Propylene Elastomer Film)

A monolayer film of a propylene elastomer with a thickness of 10 µm was produced as described in Example 5, except that instead of a polymethylpentene, a propylene elastomer (“Vistamaxx 6102” from Exxon Mobil Corporation, MFR (temperature: 230° C., load: 2160 g) = 3 g/10 min, ethylene: 16% by mass, propylene: 84 % by mass, density: 0.862 g/cm³, melting point: 48° C.) was used and a cylinder temperature of a monolayer extruder was changed to 230° C. and a cooling roll temperature was changed to 10° C.

A multilayer film and pouches were produced as described in Example 3, except that the obtained film of the propylene elastomer (thickness: 10 µm, WVTR = 60 g/m²·day, melting point_{:} 48° C.) was used as layer (A), and various evaluations were performed. The results are shown in Table 2.

TABLE 1

| | Layer (A) | | | | | | Layer (B) | Layer (C) | Layer configuration (thickness of each layer [µm]) | Heat sealability | | Oxygen concentration [ppm] | | b value after kneading |
|---|---|---|---|---|---|---|---|---|---|---|---|---|---|---|
| | Type | WVTR [g/m²•day] | Tm [°C] | ΔH [J/g] | Integral ratio (Y/X) | Density [g/cm³] | Layer configuration (thickness of each layer [µm]) | Type | | Water leakage | Shape retainability | Before treatment | After treatment | |
| Example 1 | Polymethylpentene film | 360 | 227 | 13 | - | 0.834 | EVOH-1 (20) | PP-4 | A/Tie-2/B/Tie-1/C (10/2/20/10/100) | A | A | 2.0 | 5.5 | 3.2 |
| Example 2 | Polymethylpentene film | 360 | 227 | 13 | - | 0.834 | EVOH-1/EVOH-2 (10/10) | PP-4 | A/Tie-2/B/Tie-1/C (10/2/20/10/100) | A | A | 2.0 | 4.5 | 3.5 |
| Example 3 | Polymethylpentene film | 360 | 227 | 13 | - | 0.834 | EVOH-1/EVOH-3 (10/10) | PP-4 | A/Tie-2/B/Tie-1/C (10/2/20/10/100) | A | A | 2.0 | 0.4 | 5.6 |
| Example 4 | Polymethylpentene film | 360 | 227 | 13 | - | 0.834 | EVOH-1/EVOH-4 (10/10) | PP-4 | A/Tie-2/B/Tie-1/C (10/2/20/10/100) | A | A | 2.0 | 0.7 | 4.5 |
| Example 5 | Polymethylpentene film | 36 | 227 | 13 | - | 0.834 | EVOH-1/EVOH-3 (10/10) | PP-4 | A/Tie-2/B/Tie-1/C (100/2/20/10/100) | A | A | 2.0 | 0.4 | 2.2 |
| Example 6 | Biaxially oriented polymethylpentene film | 330 | 227 | 13 | - | 0.835 | EVOH-1/EVOH-3 (10/10) | PP-4 | A/Tie-2/B/Tie-1/C (10/2/20/10/100) | A | A | 2.0 | 0.5 | 5.5 |
| Example 7 | Biaxially oriented polypropylene film | 21 | 160 | 64 | 2.3 | 0.895 | EVOH-1/EVOH-3 (10/10) | PP-4 | A/Tie-2/B/Tie-1/C (20/2/20/10/100) | A | A | 2.0 | 4.5 | 6.2 |
| Example 8 | Biaxially oriented polypropylene film | 63 | 149 | 40 | 4.8 | 0.888 | EVOH-1/EVOH-3 (10/10) | PP-4 | A/Tie-2/B/Tie-1/C (8/2/20/10/100) | A | A | 2.0 | 0.8 | 6.5 |
| Example 9 | Unstretched polypropylene film | 30 | 163 | 80 | 2.0 | 0.899 | EVOH-1/EVOH-3 (10/10) | PP-4 | A/Tie-2/B/Tie-1/C (18/2/20/10/100) | A | B | 2.0 | 1.7 | 6.2 |
| Example 10 | Unstretched polypropylene film | 28 | 149 | 59 | 1.5 | 0.899 | EVOH-1/EVOH-3 (10/10) | PP-4 | A/Tie-2/B/Tie-1/C (10/2/20/10/100) | A | B | 2.0 | 1.8 | 6.4 |
| Example 11 | Porous polypropylene film | 2900 | 164 | 83 | 1.0 | 0.908 | EVOH-1/EVOH-3 (10/10) | PP-4 | A/Tie-2/B/Tie-1/C (30/2/20/10/100) | A | A | 2.0 | 0.8 | 4.8 |

Tie-1: adhesive resin (Admer QF500)
Tie-2: aliphatic ester adhesive (Takelac A520 and Takenate A50)
EVOH-1: EVAL E171B (ethylene unit content: 44 mol%)
EVOH-2: EVAL L171B (ethylene unit content: 27 mol%,)
EVOH-3: EVAL F101B (ethylene unit content: 32 mol%): 92 parts by mass, polyoctenylene (VESTENAMER 8020): 8 parts by mass
EVOH-4: EVAL F101B (ethylene unit content: 32 mol%): 90 parts by mass, EPDM (NORDEL IP4725P): 10 parts by mass
PP-1: polypropylene (EG7FTB)
PP-4: polypropylene (NOVATEC PP EA7AD)

TABLE 2

| | Layer (A) | | | | | | Layer (B) | Layer (C) | Layer configuration (thickness of each layer[µm]) | Heat sealability | | Oxygen concentration [ppm] | | b value after kneading |
|---|---|---|---|---|---|---|---|---|---|---|---|---|---|---|
| | Type | WVTR [g/m²•day] | Tm [°C] | ΔH [J/g] | Integral ratio (Y/X) | Density [g/cm³] | Layer configuration (thickness of each layer [µm]) | Type | | Water leakage | Shape retainability | Before treatment | After treatment | |
| Example 12 | Polymethylpentene, Absortomer | 80 | 225 | 6.0 | | 0.836 | EVOH-1/EVOH-3 (10/10) | PP-4 | A/Tie-3/B/Tie-1/C (10/5/20/10/100) | A | B | 2.0 | 0.4 | 5.3 |
| Example 13 | PP-1 | 32 | 149 | 59 | 1.5 | 0.899 | EVOH-1 (20) | PP-2 | A/Tie-1/B/Tie-1/C (10/5/20/10/100) | A | A | 2.0 | 6.8 | 4.7 |
| Example 14 | PP-1 | 32 | 149 | 59 | 1.5 | 0.899 | EVOH-1/EVOH-3 (10/10) | PP-2 | A/Tie-1/B/Tie-1/C (10/5/20/10/100) | A | A | 2.0 | 2.2 | 5.7 |
| Example 15 | PP-3 | 38 | 149 | 53 | 2.4 | 0.895 | EVOH-1/EVOH-3 (10/10) | PP-2 | A/Tie-1/B/Tie-1/C (10/5/20/10/100) | A | A | 2.0 | 1.5 | 5.9 |
| Example 16 | PP-3 | 38 | 149 | 53 | 2.4 | 0.895 | EVOH-1/EVOH-5 (10/10) | PP-2 | A/Tie-1/B/Tie-1/C (10/5/20/10/100) | A | A | 2.0 | 1.4 | 7.2 |
| Comparative Example 1 | Biaxially oriented polypropylene film | 5.6 | 164 | 83 | 1.0 | 0.908 | EVOH-1 (20) | PP-4 | A/Tie-2/B/Tie-1/C (20/2/20/10/100) | A | A | 2.0 | 8.4 | 3.9 |
| Comparative Example 2 | Biaxially oriented polypropylene film | 5.6 | 164 | 83 | 1.0 | 0.908 | EVOH-1/EVOH-3 (10/10) | PP-4 | A/Tie-2/B/Tie-1/C (20/2/20/10/100) | A | A | 2.0 | 8.2 | 6.2 |
| Comparative Example 3 | Biaxially oriented Nylon film | 200 | 220 | 50 | - | 1.15 | EVOH-1/EVOH-3 (10/10) | PP-4 | A/Tie-2/B/Tie-1/C (15/2/20/10/100) | A | A | 2.0 | 0.4 | 12.5 |
| Comparative Example 4 | Linear low-density polyethylene film | 50 | 120 | 99 | - | 0.919 | EVOH-1/EVOH-3 (10/10) | PP-4 | A/Tie-2/B/Tie-1/C (10/2/20/10/100) | B | B | Pouch could not be produced | | 4.5 |
| Comparative Example 5 | PP-1 | 11 | 149 | 59 | 1.5 | 0.902 | EVOH-1 (20) | PP-2 | A/Tie-1/B/Tie-1/C (30/5/20/10/100) | A | A | 2.0 | 8.2 | 3.8 |
| Comparative Example 6 | PP-3 | 38 | 149 | 53 | 2.4 | 0.895 | EVOH-6 (20) | PP-2 | A/Tie-1/B/Tie-1/C (10/5/20/10/100) | A | A | 2.0 | 1.8 | 10.4 |
| Comparative Example 7 | Propylene elastomer | 60 | 48 | 15 | 3.1 | 0.862 | EVOH-1/EVOH-3 (10/10) | PP-4 | A/Tie-2/B/Tie-1/C (10/2/20/10/100) | B | B | Pouch could not be produced | | 4.8 |

Tie-1: adhesive resin (Admer QF500), Tie-2: aliphatic ester adhesive (Takelac A520 and Takenate A50)
Tie-3: adhesive resin (Admer QF500 50 parts by mass/Absortomer EP-1013 50 parts by mass)
EVOH-1: EVAL E171B (ethylene unit content: 44 mol%), EVOH-3: EVAL F101B (ethylene unit content: 32 mol%): 92 parts by mass, polyoctenylene (VESTENAMER 8020): 8 parts by mass
EVOH-5: EVOH-3 (ethylene unit content: 32 mol%): 85 parts by mass, Ny6 (UBE Nylon 1013A): 15 parts by mass
EVOH-6_{:} EVOH-3 (ethylene unit content: 32 mol%)_{:} 50 parts by mass, Ny6 (UBE Nylon 1013A)_{:} 50 parts by mass
PP-1: polypropylene (EG7FTB), PP-2: polypropylene (EG7FTB): 70 parts by mass, propylene elastomer (Vistamaxx 6102): 30 parts by mass
PP-3: polypropylene (EG7FTB): 90 parts by mass, propylene elastomer (Vistamaxx 6102): 10 parts by mass, PP-4: polypropylene (NOVATEC PP EA7AD)

The multilayer structures of Comparative Examples 1 and 2, which were produced using a biaxially oriented polypropylene film with a thickness of 20 µm and WVTR=5.6 g/m²·day, commonly used as the outermost layer of a packaging material, had insufficient gas barrier properties after retorting. In contrast, multilayer structures of Examples 1 to 16 produced using a polyolefin film with a higher water vapor transmission rate (WVTR: 20 g/m²·day or more), such as a thin biaxially oriented polypropylene film [for example, FOR (Futamura Chemical Co., Ltd., laminate grade, thickness: 12 µm, water vapor transmission rate: 12.3 g/m²·day)] or a special biaxially oriented polypropylene film with a higher water vapor transmission rate [for example, OPP FILM-BF (Filmax corporation, thickness: 15 µm, WVTR=15 g/m²·day), PORO-FF1 (Futamura Chemical Co., Ltd., air permeable grade, thickness: 30 µm, water vapor transmission rate: 16.0 g/m²·day)] as an outer layer (layer (A)), had high gas barrier properties after retorting. Among these, when a polymethylpentene was used (Examples 1 to 5 and 12), the layer (A) had a higher water vapor transmission rate, leading to remarkably higher gas barrier properties after retorting. Furthermore, a resin composition prepared by melt-kneading the obtained multilayer structure was highly transparent. Furthermore, the multilayer structure of Example 7 produced using a special biaxially oriented polypropylene film with remarkably higher water vapor transmission rate (thickness: 20 µm, WVTR=21 g/m²·day) as a layer (A) had high gas barrier properties after retorting. Thus, a biaxially oriented polypropylene film with a water vapor transmission rate of 10 g/m²·day or more and a thickness of 20 µm or more exhibits higher stiffness and improved pinhole resistance, and is, therefore, particularly suitably used as a layer (A).

### Example 17

### (Production of an Oxygen Barrier Film)

Pellets of EVOH-7 (“EVAL” F101B from Kuraray Co., Ltd., ethylene unit content: 32 mol%, saponification degree: 99.9 mol%, MFR (temperature: 190° C., load: 2160 g): 1 g/10 min) were fed into a monolayer extruder (screw diameter: 20 mmφ, L/D=20, from Toyo Seiki Seisaku-sho, Ltd.), and melt-kneaded under the conditions of a cylinder temperature of 210° C. and a screw rotation speed of 40 rpm, and then cast through a die to a cooling roll at 50° C., to give a monolayer film of EVOH-7 with a thickness of 20 µm.

### (Production of a Multilayer Film)

As a layer (A), a polymethylpentene film (“FORWRAP” from Riken fabro Corporation, thickness: 10 µm, WVTR=360 g/m²·day, melting point_{:} 227° C.) was used. One side of the film was corona-treated, and to the corona-treated side was applied a 2-component adhesive for dry laminate Tie-2 by a bar coater such that a thickness after drying was to be 2 µm, and it was dried in an oven at 80° C. for 3 minutes. Subsequently, in a hot laminator at a roll temperature of 70° C., the adhesive Tie-2-applied side of the polymethylpentene film and the oxygen barrier film EVOH-7 were laminated. Furthermore, Tie-2 was applied to an aluminum-deposited side of an aluminum-deposited unstretched polypropylene film (“ML CP WS” from Mitsui Chemicals Tohcello, Inc., thickness: 40 µm, WVTR=0.3 g/m²·day, melting point: 155° C.) by a bar coater such that a thickness after drying was to be 2 µm, and it was dried in an oven at 80° C. for 3 min. Subsequently, in a hot laminator at a roll temperature of 70° C., the adhesive Tie-2-applied side of the Tie-2-applied aluminum-deposited unstretched polypropylene film and EVOH-7 side of the polymethylpentene film/Tie-2/EVOH-7 multilayer film were laminated to obtain a multilayer film having the layer (A), the layer (B), and the layer (C) in this sequence. A layer configuration of the multilayer film is shown in Table 3.

### (Production of a Multilayer Film for Reference)

An adhesive Tie-2 was applied to one side of a biaxially oriented Nylon film (“EMBLEM ONBC” from UNITIKA LTD., thickness: 15 µm, both sides corona-treated, WVTR=200 g/m²·day, melting point: 220° C.) by a bar coater such that a thickness after drying was to be 2 µm, and dried in an oven at 80° C. for 3 min. Subsequently, in a hot laminator at a roll temperature of 70° C., the adhesive Tie-2-applied side of the biaxially oriented Nylon film and a printed side of an oxygen barrier properties film (“KURARISTER C” from Kuraray Co., Ltd., thickness: 12 µm) were laminated. Furthermore, Tie-2 was applied to a corona-treated side of an unstretched polypropylene film (“CP RXC-22” from Mitsui Chemicals Tohcello, Inc., thickness: 50 µm, one side corona-treated) by a bar coater such that a thickness after drying was to be 2 µm, and it was dried in an oven at 80° C. for 3 min. Subsequently, in a hot laminator at a roll temperature of 70° C., the Tie-2-applied side of the Tie-2-applied unstretched polypropylene film and the biaxially oriented Nylon side of the multilayer film made of KURARISTER C/Tie-2/biaxially oriented Nylon film were laminated, to give a multilayer film having a configuration of KURARISTER C/Tie-2/biaxially oriented Nylon film/Tie-2/unstretched polypropylene film.

### (Production of Pouches)

The multilayer film having layer (A), layer (B), layer (D) and layer (C) in this sequence and the multilayer film for reference, which were produced above, were stored in a thermostatic chamber at 40° C. for 3 days, to cure the adhesive. Then, each of these two multilayer films was cut into one 11 cm square piece. The layer (C) of the multilayer film having layer (A), layer (B), layer (D) and layer (C) in this sequence and the unstretched polypropylene film of the multilayer film for reference were laminated such that these sides were in contact with each other. Then, each of the three sides of these multilayer films was heat-sealed at 0.5 cm width for 3 sec by a hot-plate sealer heated to 160° C., to produce 10 bags (pouches) of the multilayer film, and various evaluations were performed. The results are shown in Table 3.

### Example 18

A multilayer film and pouches were produced as described in Example 17, except that in production of a multilayer film, EVOH-3 produced as described in Example 3 was used instead of EVOH-7, and various evaluations were performed. The results are shown in Table 3.

### Example 19

A multilayer film and pouches were produced as described in Example 17, except that in production of a multilayer film, EVOH-4 produced as described in Example 4 was used instead of EVOH-7, and various evaluations were performed. The results are shown in Table 3.

### Example 20

One side of a biaxially oriented polymethylpentene film (thickness: 10 µm) produced as described in Example 6 was corona-treated.

A multilayer film and pouches were produced as described in Example 18, substituting the biaxially oriented polymethylpentene film obtained for a polymethylpentene film (“FORWRAP” from Riken fabro Corporation, thickness: 10 µm, WVTR=360 g/m²·day, melting point: 227° C.) as a layer (A), and various evaluations were performed. The results are shown in Table 3.

### Example 21

A multilayer film having a layer (A), a layer (B), a layer (D) and a layer (C) in this sequence and pouches were produced as described in Example 18, except that a biaxially oriented polypropylene film (“PORO-FL2” from Futamura Chemical Co., Ltd., thickness: 20 µm, WVTR=21 g/m²·day, melting point_{:} 160° C., polypropylene content: 75% by mass or more, propylene unit content in the polypropylene: 98 % by mass or more) was used as the layer (A), and various evaluations were performed. The results are shown in Table 3.

### Example 22

A multilayer film and pouches were produced as described in Example 18, except that a biaxially oriented polypropylene film (“PORO-FF1” from Futamura Chemical Co., Ltd., thickness: 30 µm, WVTR=16 g/m²·day, melting point: 160° C., polypropylene content: 75% by mass or more, propylene unit content in the polypropylene: 98% by mass or more) was used as a layer (A), and various evaluations were performed. The results are shown in Table 3.

### Example 23

A multilayer film and pouches were produced as described in Example 18, except that a biaxially oriented polypropylene film (OPP FILM-BF(Filmax Corporation, thickness: 15 µm, WVTR=15 g/m²·day), melting point_{:} 160° C., polypropylene content: 80% by mass or more, propylene unit content in the polypropylene: 98% by mass or more) was used as a layer (A), and various evaluations were performed. The results are shown in Table 3.

### Example 24

A multilayer film and pouches were produced as described in Example 18, except that a biaxially oriented polypropylene film (“FOR” from Futamura Chemical Co., Ltd., thickness: 12 µm, WVTR=12 g/m²·day, melting point_{:} 163° C., polypropylene content: 90% by mass or more, propylene unit content in the polypropylene: 98 % by mass or more) was used as a layer (A), and various evaluations were performed. The results are shown in Table 3.

### Example 25

One side of a biaxially oriented polypropylene film (thickness: 8 µm) produced as described in Example 8 was corona-treated.

A multilayer film and pouches were produced as described in Example 18, except that the obtained biaxially oriented polypropylene film (thickness: 8 µm, WVTR=63 g/m²·day, melting point: 149° C.) was used as a layer (A), and various evaluations were performed. The results are shown in Table 3.

### Example 26

### (Production of an Unstretched Polyolefin Film)

A multilayer film and pouches were produced as described in Example 18, except that an unstretched polypropylene film (“GLC” from Mitsui Chemicals Tohcello, Inc., thickness: 18 µm, WVTR=30 g/m²·day, melting point: 163° C., polypropylene content: 80% by mass or more, propylene unit content in the polypropylene: 98% by mass or more) was used as a layer (A), and various evaluations were performed. The results are shown in Table 3.

### Example 27

A multilayer film and pouches were produced as described in Example 18, except that an unstretched polypropylene film (thickness: 10 µm, WVTR=28 g/m²·day, melting point_{:} 149° C.) produced as described in Example 10 was used as layer (A), and various evaluations were performed. The results are shown in Table 3.

### Example 28

A multilayer film and pouches were produced as described in Example 21, except that an aluminum-deposited biaxially oriented polypropylene film (“ML HC-OP” from Mitsui Chemicals Tohcello, Inc., total thickness: 30 µm, thickness of a deposited aluminum layer: 50 nm, WVTR=0.3 g/m²·day) was used as a layer (D) and a layer (C), and various evaluations were performed. The results are shown in Table 3.

### Example 29

### (Production of a Coextruded Film)

Into each of three-material three-layer multilayer extruders were fed the polyolefin resin PO-1 produced as described in Example 12 and adhesive resin Tie-3, and EVOH-7, and layers of the resins were cast through a die to a cooling roll at 80° C. under the conditions of an extrusion temperature of 210 to235° C. and a die temperature of 235° C. such that EVOH-7 was in contact with the cooling roll, to give a three-material three-layer coextruded film having a layer (A) and a layer (B). A multilayer film and pouches were produced as described in Example 17, substituting the obtained coextruded film for a multilayer film of polymethylpentene film/Tie-2/EVOH-7, and various evaluations were performed. A film thickness of each layer and evaluation results are shown in Table 4.

### Example 30

A WVTR of a biaxially oriented polypropylene film (thickness: 10 µm) produced as described in Example 13 was 32 g/m²·day.

### (Production of a Co-Extruded Sheet)

Into each of three-material three-layer multilayer extruders were fed a polypropylene resin PP-1, an adhesive resin Tie-1 and EVOH-7, and layers of the resins were cast through a die to a cooling roll at 80° C. under the conditions of an extrusion temperature of 210 to 235° C. and a die temperature of 235° C. such that the polypropylene resin PP-1 was in contact with the cooling roll, to give a three-material three-layer co-extruded sheet comprising a layer (A) and a layer (B) with a layer configuration of PP-1 (60 µm)/Tie-1 (30 µm)/EVOH-7 (120 µm).

### (Production of a Co-Oriented Film)

The co-extruded sheet obtained (210 µm) was cut into a 10 cm square piece, which was then subjected to simultaneous biaxial stretching 2.5 times in a longitudinal direction and 2.5 times in a vertical direction using a biaxial stretching machine under the following conditions, to produce a co-oriented film. A layer configuration of the obtained co-oriented film was as shown in Table 4.
Preheating temperature: 140° C.
Preheating time: 1.5 min
Stretching speed: 0.1 m/min
Heat setting temperature: 140° C.
Heat setting time: 1 min

### (Production of a Multilayer Film)

A multilayer film and pouches having a layer (A), a layer (B), a layer (D) and a layer (C) in this sequence were produced as described in Example 17, except that the obtained co-oriented film was used instead of the multilayer film of polymethylpentene film/Tie-2/EVOH-7 and the EVOH-7 side of the co-oriented film and the Tie-2-applied side of the Tie-2-applied aluminum-deposited unstretched polypropylene film were laminated, and various evaluations were performed. A film thickness of each layer and the evaluation results are shown in Table 4.

### Example 31

A multilayer film and pouches were produced as described in Example 30, except that EVOH-3 was used as a layer (B), and various evaluations were performed. A film thickness of each layer and the evaluation results are shown in Table 4.

### Example 32

A WVTR of a biaxially oriented polypropylene film (thickness: 10 µm) produced as described in Example 15 was 38 g/m²·day.

### (Production of a Multilayer Film)

A multilayer film having a layer (A), a layer (B), a layer (D) and a layer (C) in this sequence and pouches were produced as described in Example 31, except that PP-3 was used as a layer (A), and various evaluations were performed. A film thickness of each layer and the evaluation results are shown in Table 4.

### Example 33

### (Production of a Multilayer Film)

A multilayer film and pouches were produced as described in Example 32, except that EVOH-5 produced as described in Example 16 was used as a layer (B), and various evaluations were performed. A film thickness of each layer and the evaluation results are shown in Table 4. The pouches obtained in this example formed less wrinkles in the surface of the pouches after retorting in (6) and had better appearance even after retorting in comparison with the pouch produced in Example 31.

### Example 34

### (Production of an Aluminum-Deposited EVOH Film)

On one side of a biaxially oriented EVOH film (“EF-XL” from Kuraray Co., Ltd., ethylene unit content: 32 mol%, thickness: 12 µm, oxygen transmission rate at 20° C. and a humidity of 65%: 0.4 cm³/m²·day·atm, melting point_{:} 183° C.), aluminum was deposited to a thickness of 50 nm by a known vacuum deposition method.

### (Production of a Multilayer Film)

As a layer (A), a biaxially oriented polypropylene film (“PORO-FL2” from Futamura Chemical Co., Ltd., thickness: 20 µm, WVTR=21 g/m²·day, melting point: 160° C., polypropylene content: 75 % by mass or more, propylene unit content in the polypropylene: 98% by mass or more, both sides corona-treated) was used. To the corona-treated side of the film was applied a 2-component adhesive for dry laminate Tie-2 by a bar coater such that a thickness after drying was to be 2 µm, and it was dried in an oven at 80° C. for 3 minutes. Subsequently, in a hot laminator at a roll temperature of 70° C., the adhesive Tie-2-applied side of the film and the EVOH side of the aluminum-deposited EVOH film were laminated. Furthermore, Tie-2 was applied to the corona-treated side of (“CP RXC-22” from Mitsui Chemicals Tohcello, Inc., thickness: 50 µm, one side corona-treated) by a bar coater such that a thickness after drying was to be 2 µm, and it was dried in an oven at 80° C. for 3 min. Subsequently, in a hot laminator at a roll temperature of 70° C., the adhesive Tie-2-applied side of the Tie-2-applied unstretched polypropylene film and the aluminum-deposited side of the multilayer film of biaxially oriented polypropylene film/Tie-2/aluminum-deposited EVOH were laminated to obtain a multilayer film having a layer (A), a layer (B), a layer (D) and a layer (C) in this sequence. A layer configuration of the multilayer film is shown in Table 4.

Pouches were produced as described in Example 17, except that the above multilayer film was used, and various evaluations were performed. A film thickness of each layer and the evaluation results are shown in Table 4.

### Example 35

### (Production of a Multilayer Film)

A multilayer film having a layer (A), a layer (B), a layer (D) and a layer (C) in this sequence and pouches were produced as described in Example 34, except that a biaxially oriented polypropylene film (“FOR” from Futamura Chemical Co., Ltd., thickness: 12 µm, WVTR=12 g/m²·day, melting point_{:} 163° C., polypropylene content: 90% by mass or more, propylene unit content in the polypropylene: 98% by mass or more) was used as a layer (A), and various evaluations were performed. A film thickness of each layer and the evaluation results are shown in Table 4.

### Example 36

### (Production of an Alumina-Deposited EVOH Film)

On one side of a biaxially oriented EVOH film (“EF-XL” from Kuraray Co., Ltd., ethylene unit content: 32 mol%, thickness: 12 µm, oxygen transmission rate at 20° C. and a humidity of 65%: 0.4 cm³/m²·day·atm, melting point_{:} 183° C.), alumina was deposited to a thickness of 50 nm by a known vacuum deposition method.

### (Production of a Multilayer Film)

A multilayer film having a layer (A), a layer (B), a layer (D) and a layer (C) in this sequence and pouches were produced as described in Example 34, except that the alumina-deposited EVOH film obtained above was used as the layer (B) and the layer (D), and various evaluations were performed. A film thickness of each layer and the evaluation results are shown in Table 4.

### Example 37

### (Production of a Silica-Deposited EVOH Film)

On one side of a biaxially oriented EVOH film (“EF-XL” from Kuraray Co., Ltd., ethylene unit content: 32 mol%, thickness: 12 µm, oxygen transmission rate at 20° C. and a humidity of 65%: 0.4 cm³/m²·day·atm, melting point_{:} 183° C.), silica was deposited to a thickness of 50 nm by a known vacuum deposition method.

### (Production of a Multilayer Film)

A multilayer film having a layer (A), a layer (B), a layer (D) and a layer (C) in this sequence and pouches were produced as described in Example 34, except that the silica-deposited EVOH film obtained above was used as the layer (B) and the layer (D), and various evaluations were performed. A film thickness of each layer and the evaluation results are shown in Table 4.

### Comparative Example 8

A multilayer film and pouches were produced as described in Example 17, except that a biaxially oriented polypropylene film (“Pylen Film-OT P2161” from TOYOBO CO., LTD., thickness: 20 µm, one side corona-treated, WVTR=5.6 g/m²·day, melting point: 164° C.) was used as a layer (A), and various evaluations were performed. The results are shown in Table 4.

### Comparative Examples 9, 10 and 11

Multilayer films having a layer (A), a layer (B), a layer (D) and a layer (C) in this sequence and pouches were produced as described in Example 18, except that as the layer (A), a biaxially oriented polypropylene film (“Pylen Film-OT P2161” from TOYOBO CO., LTD., thickness: 20 µm, one side corona-treated, WVTR=5.6 g/m²·day, melting point: 164° C.) was used in Comparative Example 9, a biaxially oriented Nylon film (“EMBLEM ONBC” from UNITIKA LTD., thickness: 15 µm, both sides corona-treated, WVTR=200 g/m²·day, melting point: 220° C.) was used in Comparative Example 10, and a linear low-density polyethylene LLDPE (“ULTZEX 2022L” from Prime Polymer Co., Ltd., thickness: 20 µm, one side corona-treated, WVTR=50 g/m²·day, melting point: 120° C., MFR (temperature: 190° C., load: 2160 g): 2 g/10 min)) was used in Comparative Example 11, and various evaluations were performed. The results are shown in Table 4.

### Comparative Example 12

### (Production of a Co-Oriented Film)

A co-extruded sheet was produced as described in Example 30, except that in production of a co-extruded sheet, a thickness of PP-1 was changed such that a thickness of a layer (A) in a co-oriented film produced was to be 40 µm. A co-oriented film, a multilayer film and pouches were produced from the co-extruded sheet obtained, and various evaluations were performed. The results are shown in Table 4.

### Comparative Example 13

### (Production of a Co-Oriented Film)

A coextruded film, a co-oriented film, a multilayer film and pouches were produced as described in Example 33, except that pellets of EVOH-6 produced as described in Comparative Example 6 were used instead of EVOH-5, and various evaluations were performed. The results are shown in Table 4.

### Comparative Example 14

### (Production of a Propylene Elastomer Film)

A monolayer film made of a propylene elastomer with a thickness of 10 µm was produced as described in Example 20, except that a propylene elastomer (“Vistamaxx 6102” from Exxon Mobil Corporation, MFR (temperature: 230° C., load: 2160 g) =1.4 g/10 min, ethylene: 16% by mass, propylene: 84% by mass, density: 0.862 g/cm³, melting point: 48° C.) was used instead of a polymethylpentene, and a cylinder temperature and a cooling roll temperature of the monolayer extruder were changed to 230° C. and 10° C., respectively.

A multilayer film and pouches were produced as described in Example 18, except that the propylene elastomer film obtained (thickness: 10 µm, WVTR=60 g/m²·day, melting point: 48° C.) was used as a layer (A), and various evaluations were performed. The results are shown in Table 4.

### Comparative Example 15

### (Production of a Multilayer Film)

A multilayer film having a layer (A), a layer (B), a layer (D) and a layer (C) in this sequence and pouches were produced as described in Example 34, except that a biaxially oriented polypropylene film (“Pylen Film-OT P2161” from TOYOBO CO., LTD., thickness: 20 µm, one side corona-treated, WVTR=5.6 g/m²·day, melting point: 164° C.) was used as a layer (A), and various evaluations were performed. A film thickness of each layer and the evaluation results are shown in Table 4.

### Comparative Example 16

### (Production of an Aluminum Foil-Containing Unstretched Polypropylene Film)

Tie-2 was applied to the corona-treated side of unstretched polypropylene film (“CP RXC-22” from Mitsui Chemicals Tohcello, Inc., thickness: 50 µm, one side corona-treated) by a bar coater such that a thickness after drying was to be 2 µm, and it was dried in an oven at 80° C. for 3 min. Subsequently, in a hot laminator at a roll temperature of 70° C., the Tie-2-applied side of the Tie-2-applied unstretched polypropylene film and an aluminum foil (thickness: 12 µm) were laminated to obtain an aluminum foil-containing unstretched polypropylene film.

### (Production of a Multilayer Film)

A multilayer film having a layer (A), a layer (B), an aluminum foil layer and a layer (C) in this sequence and pouches were produced as described in Example 21, except that the aluminum foil-containing unstretched polypropylene film obtained above was used as the layer (D) and the layer (C), and various evaluations were performed. A film thickness of each layer and the evaluation results are shown in Table 4.

### Comparative Example 17

### (Production of a Multilayer Film)

A multilayer film having a layer (A), a layer (B), a layer (D) and a layer (C) in this sequence and pouches were produced as described in Example 35, except that a biaxially oriented polypropylene film (“FOR” from Futamura Chemical Co., Ltd., thickness: 30 µm, WVTR=4.8 g/m²·day, melting point_{:} 163° C., polypropylene content: 90 % by mass or more, propylene unit content in the polypropylene: 98% by mass or more) was used as the layer (A), and various evaluations were performed. A film thickness of each layer and the evaluation results are shown in Table 4.

### Comparative Example 18

### (Production of a Multilayer Film)

A multilayer film having a layer (A), a layer (B), a layer (D) and a layer (C) in this sequence and pouches were produced as described in Example 35, except that a biaxially oriented polypropylene film (“FOR” from Futamura Chemical Co., Ltd., thickness: 20 µm, WVTR=7.2 g/m²·day, melting point_{:} 163° C., polypropylene content: 90% by mass or more, propylene unit content in the polypropylene: 98% by mass or more) was used as the layer (A), and various evaluations were performed. A film thickness of each layer and the evaluation results are shown in Table 4.

### Comparative Example 19

### (Production of an Aluminum-Deposited PET Film)

On the corona-untreated side of a biaxially oriented PET film (“Lumirror S-10” from Toray Industries, Inc., thickness: 12 µm, melting point: 253° C.), aluminum was deposited to a thickness of 50 nm by a known vacuum deposition method. A WVTR of the film obtained was 0.7 g/m²·day.

### (Production of a Multilayer Film)

Tie-2 was applied to the corona-treated side of an unstretched polypropylene film (“CP RXC-22” from Mitsui Chemicals Tohcello, Inc., thickness: 50 µm, one side corona-treated) by a bar coater such that a thickness after drying was to be 2 µm, and it was dried in an oven at 80° C. for 3 min. Subsequently, in a hot laminator with a roll temperature of 70° C., the corona-treated side of the aluminum-deposited PET produced was laminated. A multilayer film having a layer (A), a layer (B), a layer (D) and a layer (C) in this sequence and pouches were produced as described in Example 21, except that the multilayer film having this PET resin layer was used as the layer (D) and the layer (C), and various evaluations were performed. A film thickness of each layer and the evaluation results are shown in Table 4. In the evaluation of fish eyes in the recycled resin in (10) above, foreign matters with a size of more than 1 mm were visually observed in the produced recycled film.

### Comparative Example 20

### (Production of a Multilayer Film)

A 2-component adhesive for dry laminate Tie-2 was applied to the corona-treated side of a biaxially oriented polypropylene film (“PORO-FL2” from Futamura Chemical Co., Ltd., thickness: 20 µm, WVTR=21 g/m²·day, melting point: 160° C., polypropylene content: 75 % by mass or more, propylene unit content in the polypropylene: 98% by mass or more) by a bar coater such that a thickness after drying was to be 2 µm, and it was dried in an oven at 80° C. for 3 min. Subsequently, in a hot laminator at a roll temperature of 70° C., the adhesive Tie-2-applied side of the biaxially oriented polypropylene film and the aluminum-deposited side of the aluminum-deposited unstretched polypropylene film (“ML CP WS” from Mitsui Chemicals Tohcello, Inc., thickness: 40 µm, WVTR=0.3 g/m²·day) were laminated to give a multilayer film having a layer (A), a layer (D) and a layer (C) in this sequence. A layer configuration of the multilayer film is shown in Table 4. Pouches were produced as described in Example 17, except that the multilayer film obtained was used, and various evaluations were performed. A film thickness of each layer and the evaluation results are shown in Table 4.

TABLE 3

| | Layer (A) | | | | | | Layer (B) | Layer (D) | Layer (C) | Layer configuration (thickness of each layer[µm]) | Heat sealability | | Oxygen concentration [ppm] | | | Recyclability by alkali treatment | b value after kneading | Fish eyes |
|---|---|---|---|---|---|---|---|---|---|---|---|---|---|---|---|---|---|---|
| | Type | WVTR [g/m²•day] | Tm [°C] | ΔH [J/g] | Integral ratio (Y/X) | Density [g/cm³] | (Thickness of each layer [µm]) | | | | Water leakage | Shape retainability | Before treatment | After 1-month storage | After 6-month storage | | | |
| Example 17 | Polymethylpentene film | 360 | 227 | 13 | - | 0.834 | EVOH-7 (20) | VM-CPP (40) | | A/Tie-2/B/Tie-2/D•C (10/2/20/2/40) | A | A | 2.0 | 3.0 | 5.1 | A | 3.5 | A |
| Example 18 | Polymethylpentene film | 360 | 227 | 13 | - | 0.834 | EVOH-3 (20) | VM-CPP (40) | | A/Tie-2/B/Tie-2/D•C (10/2/20/2/40) | A | A | 2.0 | 0.9 | 0.4 | A | 5.9 | B |
| Example 19 | Polymethylpentene film | 360 | 227 | 13 | - | 0.834 | EVOH-4 (20) | VM-CPP (40) | | A/Tie-2/B/Tie-2/D•C (10/2/20/2/40) | A | A | 2.0 | 1.2 | 0.4 | A | 4.8 | B |
| Example 20 | Biaxially oriented polymethylpentene film | 330 | 227 | 13 | - | 0.835 | EVOH-3 (20) | VM-CPP (40) | | A/Tie-2/B/Tie-2/D•C (10/2/20/2/40) | A | A | 2.0 | 1.0 | 0.4 | A | 5.8 | B |
| Example 21 | Biaxially oriented polypropylene film | 21 | 160 | 64 | 2.3 | 0.895 | EVOH-3 (20) | VM-CPP (40) | | A/Tie-2/B/Tie-2/D•C (20/2/20/2/40) | A | A | 2.0 | 1.5 | 1.0 | A | 6.5 | B |
| Example 22 | Biaxially oriented polypropylene film | 16 | 160 | 60 | 2.6 | 0.894 | EVOH-3 (20) | VM-CPP (40) | | A/Tie-2/B/Tie-2/D•C (30/2/20/2/40) | A | A | 2.0 | 1.6 | 1.4 | A | 6.4 | B |
| Example 23 | Biaxially oriented polypropylene film | 15 | 160 | 67 | 1.3 | 0.897 | EVOH-3 (20) | VM-CPP (40) | | A/Tie-2/B/Tie-2/D•C (15/2/20/2/40) | A | A | 2.0 | 1.6 | 1.5 | A | 6.8 | B |
| Example 24 | Biaxially oriented polypropylene film | 12 | 163 | 75 | 1.4 | 0.903 | EVOH-3 (20) | VM-CPP (40) | | A/Tie-2/B/Tie-2/D•C (12/2/20/2/40) | A | A | 2.0 | 1.7 | 1.9 | A | 7.0 | B |
| Example 25 | Biaxially oriented polypropylene film | 63 | 149 | 40 | 4.8 | 0.888 | EVOH-3 (20) | VM-CPP (40) | | A/Tie-2/B/Tie-2/D•C (8/2/20/2/40) | A | A | 2.0 | 1.1 | 0.7 | A | 7.2 | B |
| Example 26 | Unstretched polypropylene film | 30 | 163 | 80 | 2.0 | 0.899 | EVOH-3 (20) | VM-CPP (40) | | A/Tie-2/B/Tie-2/D•C (18/2/20/2/40) | A | B | 2.0 | 1.3 | 0.8 | A | 6.6 | B |
| Example 27 | Unstretched polypropylene film | 28 | 149 | 59 | 1.5 | 0.899 | EVOH-3 (20) | VM-CPP (40) | | A/Tie-2/B/Tie-2/D•C (10/2/20/2/40) | A | B | 2.0 | 1.4 | 0.9 | A | 6.6 | B |
| Example 28 | Biaxially oriented polypropylene film | 21 | 160 | 64 | 2.3 | 0.895 | EVOH-3 (20) | VM-OPP (30) | | A/Tie-2/B/Tie-2/D•C (20/2/20/2/30) | A | A | 2.0 | 1.3 | 0.8 | A | 7.1 | B |

Tie-1: adhesive resin (Admer QF500), Tie-2: aliphatic ester adhesive (Takelac A520 and Takenate A50)
EVOH-7: EVAL F101B (ethylene unit content: 32 mol%), EVOH-3: EVAL F101B (ethylene unit content: 32 mol%)_{:} 92 parts by mass, polyoctenylene (VESTENAMER 8020): 8 parts by mass
EVOH-4: EVAL F101B (ethylene unit content: 32 mol%): 90 parts by mass, EPDM (NORDEL IP4725P): 10 parts by mass
PP-1: polypropylene (EG7FTB), PP-4: polypropylene (NOVATEC PP EA7AD)
VM-CPP: ML CP WS (film thickness: 40 µm, aluminum deposition thickness: 50 nm), VM-OPP:ML HCOP (film thickness: 30um, aluminum deposition thickness: 50 nm)

TABLE 4

| | Layer (A) | | | | | | Layer (B) | Layer (D) | Layer (C) | Layer configuration (thickness of each layer[µm]) | Heat sealability | | Oxygen concentration [ppm] | | | Recyclability by alkali treatment | b value after kneading | Fish eyes |
|---|---|---|---|---|---|---|---|---|---|---|---|---|---|---|---|---|---|---|
| | Type | WVTR [g/m²•day] | Tm [°C] | ΔH [J/g] | Integral ratio (Y/X) | Density [g/cm³] | (Thickness of each layer [µm]) | | | | Water leakage | Shape retainability | Before treatment | After 1-month storage | After 6-month storage | | | |
| Example 29 | Polymethylpentene, Absortomer | 80 | 225 | 6.0 | - | 0.836 | EVOH-7 (20) | VM-CPP (40) | | A/Tie-3/B/Tie-2/D•C (10/5/20/2/40) | A | A | 2.0 | 3.6 | 5.6 | A | 3.7 | B |
| Example 30 | PP-1 | 32 | 149 | 59 | 1.5 | 0.899 | EVOH-7 (20) | VM-CPP (40) | | A/Tie-1/B/Tie-2/D•C (10/5/20/2/40) | A | A | 2.0 | 4.1 | 6.1 | A | 4.1 | B |
| Example 31 | PP-1 | 32 | 149 | 59 | 1.5 | 0.899 | EVOH-3 (20) | VM-CPP (40) | | A/Tie-1/B/Tie-2/D•C (10/5/20/2/40) | A | A | 2.0 | 1.3 | 0.8 | A | 6.5 | B |
| Example 32 | PP-3 | 38 | 149 | 53 | 2.4 | 0.895 | EVOH-3 (20) | VM-CPP (40) | | A/Tie-1/B/Tie-2/D•C (10/5/20/2/40) | A | A | 2.0 | 1.2 | 0.7 | A | 6.6 | B |
| Example 33 | PP-3 | 38 | 149 | 53 | 2.4 | 0.895 | EVOH-5 (20) | VM-CPP (40) | | A/Tie-1/B/Tie-2/D•C (10/5/20/2/40) | A | A | 2.0 | 1.1 | 0.6 | A | 7.0 | B |
| Example 34 | Biaxially oriented polypropylene film | 21 | 160 | 64 | 2.3 | 0.895 | Aluminum-deposited EVOH (12) | | CPP (50) | A/Tie-2/B•D/Tie-2/C (20/2/12/2/50) | A | A | 2.0 | 3.8 | 5.8 | B | 3.9 | A |
| Example 35 | Biaxially oriented polypropylene film | 12 | 163 | 75 | 1.4 | 0.903 | Aluminum-deposited EVOH (12) | | CPP (50) | A/Tie-2/B•D/Tie-2/C (12/2/12/2/50) | A | A | 2.0 | 4.0 | 6.0 | B | 4.3 | A |
| Example 36 | Biaxially oriented polypropylene film | 21 | 160 | 64 | 2.3 | 0.895 | Alumina-deposited EVOH (12) | | CPP (50) | A/Tie-2/B•D/Tie-2/C (20/2/12/2/50) | A | A | 2.0 | 4.2 | 6.2 | A | 4.0 | B |
| Example 37 | Biaxially oriented polypropylene film | 21 | 160 | 64 | 2.3 | 0.895 | Silica-deposited EVOH (12) | | CPP (50) | A/Tie-2/B•D/Tie-2/C (20/2/12/2/50) | A | A | 2.0 | 4.3 | 6.3 | A | 4.1 | B |
| Comparative Example 8 | Biaxially oriented polypropylene film | 5.6 | 164 | 83 | 1.0 | 0.908 | EVOH-7 (20) | VM-CPP (40) | | A/Tie-2/B/Tie-2/D•C (20/2/20/2/40) | A | A | 2.0 | 8.3 | 8.4 | A | 3.8 | A |
| Comparative Example 9 | Biaxially oriented polypropylene film | 5.6 | 164 | 83 | 1.0 | 0.908 | EVOH-3 (20) | VM-CPP (40) | | A/Tie-2/B/Tie-2/D•C (20/2/20/2/40) | A | A | 2.0 | 2.0 | 6.9 | A | 6.2 | B |

Tie-1: adhesive resin (Admer QF500), Tie-2: aliphatic ester adhesive (Takelac A520 and Takenate A50), Tie-3: adhesive resin (Admer QF500: 50 parts by mass/Absortomer EP-1013: 50 parts by mass)
EVOH-7: EVAL F101B (ethylene unit content: 32 mol%), EVOH-3: EVAL F101B (ethylene unit content: 32 mol%)_{:} 92 parts by mass, polyoctenylene (VESTENAMER 8020): 8 parts by mass
EVOH-5: EVOH-3 (ethylene unit content: 32 mol%): 85 parts by mass, Ny6 (UBE Nylon 1013A): 15 parts by mass
EVOH-6: EVOH-3 (ethylene unit content: 32 mol%): 50 parts by mass, Ny6 (UBE Nylon 1013A): 50 parts by mass
PP-1: polypropylene (EG7FTB), PP-2: polypropylene (EG7FTB): 70 parts by mass, propylene elastomer (Vistamaxx 6102): 30 parts by mass
PP-3: polypropylene (EG7FTB): 90 parts by mass, propylene elastomer (Vistamaxx 6102): 10 parts by mass, PP-4: polypropylene (NOVATEC PP EA7AD)
VM-CPP: CP WS (film thickness: 40 µm, aluminum deposition thickness: 50 nm), VM-OPP: HCOP (film thickness: 30 µm, aluminum deposition thickness: 50 nm)
CPP: RXC-22 (film thickness: 50 µm), VM-PET: PET-C (film thickness: 12 µm, aluminum deposition thickness: 50 nm)

[TABLE 4] continued

| | Layer (A) | | | | | | Layer (B) | Layer (D) | Layer (C) | Layer configuration (thickness of each layer[µm]) | Heat sealability | | Oxygen concentration [ppm] | | | Recyclability by alkali treatment | b value after kneading | Fish eyes |
|---|---|---|---|---|---|---|---|---|---|---|---|---|---|---|---|---|---|---|
| | Type | WVTR [g/m²•day] | Tm [°C] | ΔH [J/g] | Integral ratio (Y/X) | Density [g/cm³] | (Thickness of each layer[µm]) | | | | Water leakage | Shape retainability | Before treatment | After 1-month storage | After 6-month storage | | | |
| Comparative Example 10 | Biaxially oriented Nylon film | 200 | 220 | 50 | - | 1.15 | EVOH-3 (20) | VM-CPP (40) | | A/Tie-2/B/Tie-2/D•C (15/2/20/2/40) | A | A | 2.0 | 0.8 | 0.5 | A | 13.5 | B |
| Comparative Example 11 | Linear low-density polyethylene film | 50 | 120 | 99 | - | 0.919 | EVOH-3 (20) | VM-CPP (40) | | A/Tie-2/B/Tie-2/D•C (20/2/20/2/40) | B | B | Pouch could not be produced | | | A | 6.3 | B |
| Comparative Example 12 | PP-1 | 8 | 149 | 59 | 1.5 | 0.902 | EVOH-7 (20) | VM-CPP (40) | | A/Tie-1/B/Tie-2/D•C (40/5/20/2/40) | A | A | 2.0 | 8.3 | 8.4 | A | 3.9 | B |
| Comparative Example 13 | PP-3 | 38 | 149 | 53 | 2.4 | 0.895 | EVOH-6 (20) | VM-CPP (40) | | A/Tie-1/B/Tie-2/D•C (10/5/20/2/40) | A | A | 2.0 | 1.5 | 4.6 | A | 10.5 | B |
| Comparative Example 14 | propylene elastomer | 60 | 48 | 15 | 3.1 | 0.862 | EVOH-3 (20) | VM-CPP (40) | | A/Tie-2/B/Tie-2/D•C (10/2/20/2/40) | B | B | Pouch could not be produced | | | A | 7.1 | B |
| Comparative Example 15 | Biaxially oriented polypropylene film | 5.6 | 164 | 83 | 1.0 | 0.908 | Aluminum-deposited EVOH (12) | | CPP (50) | A/Tie-2/B•D/Tie-2/C (20/2/12/2/50) | A | A | 2.0 | 7.2 | 8.3 | B | 3.8 | B |
| Comparative Example 16 | Biaxially oriented polypropylene film | 21 | 160 | 64 | 2.3 | 0.895 | EVOH-3 (20) | Aluminum foil (12) | CPP (50) | A/Tie-2/B/D/Tie-2/C (20/2/20/12/2/50) | A | A | 2.0 | 0.6 | 0.3 | C | 7.2 | D |
| Comparative Example 17 | Biaxially oriented polypropylene film | 4.8 | 163 | 75 | 1.4 | 0.903 | Aluminum-deposited EVOH (12) | | CPP (50) | A/Tie-2/B•D/Tie-2/C (30/2/12/2/50) | A | A | 2.0 | 8.4 | 8.4 | B | 3.7 | A |
| Comparative Example 18 | Biaxially oriented polypropylene film | 7.2 | 163 | 75 | 1.4 | 0.903 | Aluminum-deposited EVOH (12) | | CPP (50) | A/Tie-2/B•D/Tie-2/C (20/2/12/2/50) | A | A | 2.0 | 6.2 | 7.8 | B | 3.8 | A |
| Comparative Example 19 | Biaxially oriented polypropylene film | 21 | 160 | 64 | 2.3 | 0.895 | EVOH-3 (20) | VM-PET (12) | CPP (50) | A/Tie-2/B/D/Tie-2/C (20/2/20/12/2/50) | A | A | 2.0 | 1.4 | 0.9 | B | 6.5 | C |
| Comparative Example 20 | Biaxially oriented polypropylene film | 21 | 160 | 64 | 2.3 | 0.895 | None | VM-CPP (40) | | A/Tie-2/D•C (20/2/40) | A | A | 2.0 | 8.3 | 8.4 | A | 2.5 | A |

Tie-1: adhesive resin (Admer QF500), Tie-2: aliphatic ester adhesive (Takelac A520 and Takenate A50), Tie-3: adhesive resin (Admer QF500: 50 parts by mass/Absortomer EP-1013: 50 parts by mass) EVOH-7: EVAL F101B (ethylene unit content: 32 mol%), EVOH-3: EVAL F101B (ethylene unit content: 32 mol%): 92 parts by mass, polyoctenylene (VESTENAMER 8020): 8 parts by mass
EVOH-5: EVOH-3 (ethylene unit content: 32 mol%): 85 parts by mass, Ny6 (UBE Nylon 1013A): 15 parts by mass
EVOH-6: EVOH-3 (ethylene unit content: 32 mol%): 50 parts by mass, Ny6 (UBE Nylon 1013A): 50 parts by mass
PP-1: polypropylene (EG7FTB), PP-2: polypropylene (EG7FTB): 70 parts by mass, propylene elastomer (Vistamaxx 6102): 30 parts by mass
PP-3: polypropylene (EG7FTB): 90 parts by mass, propylene elastomer (Vistamaxx 6102): 10 parts by mass, PP-4: polypropylene (NOVATEC PP EA7AD)
VM-CPP: CP WS (film thickness: 40 µm, aluminum deposition thickness: 50 nm), VM-OPP: HCOP (film thickness: 30 µm, aluminum deposition thickness: 50 nm)
CPP: RXC-22 (film thickness: 50 µm), VM-PET: PET-C (film thickness: 12 µm, aluminum deposition thickness: 50 nm)

The multilayer structures of Comparative Examples 8 and 9, which were produced using a biaxially oriented polypropylene film with a thickness of 20 µm and WVTR=5.6 g/m²·day, commonly used as the outermost layer of a packaging material, had insufficient gas barrier properties after retorting. In contrast, multilayer structures of Examples 17 to 37 produced using a polyolefin film with a higher water vapor transmission rate (WVTR: 10 g/m²·day or more), such as a thin biaxially oriented polypropylene film (for example, FOR (Futamura Chemical Co., Ltd., laminate grade, thickness: 12 µm, water vapor transmission rate: 12.3 g/m²·day)) or a special biaxially oriented polypropylene film with a higher water vapor transmission rate [for example, OPP FILM-BF (Filmax corporation, thickness: 15 µm, WVTR=15 g/m²·day), PORO-FF1 (Futamura Chemical Co., Ltd., air permeable grade, thickness: 30 µm, water vapor transmission rate: 16.0 g/m²·day)] as an outer layer (layer (A)), had high gas barrier properties after retorting. Among these, when a polymethylpentene was used (Examples 17 to 20 and 29), the layer (A) had a higher water vapor transmission rate, leading to remarkably higher gas barrier properties after retorting. Furthermore, a resin composition prepared by melt-kneading the obtained multilayer structure was highly transparent. The multilayer structures of Examples 21, 34, 36 and 37 using a special biaxially oriented polypropylene film with a thickness of 20 µm, a WVTR=21 g/m²·day and remarkably higher water vapor transmission rate as a layer (A) exhibited higher barrier properties after retorting in comparison with the multilayer structures using a biaxially oriented polypropylene film generally used with a thickness of 20 µm and a WVTR=5.6 g/m²·day (Comparative Examples 17, 18, 24), or a thickness of 30 µm and a WVTR=4.8 g/m²·day (Comparative Example 26), or a thickness of 20 µm and a WVTR=7.2 g/m²·day (Comparative Example 27) as a layer (A). Thus, a biaxially oriented polypropylene film with a water vapor transmission rate of 10 g/m²·day or more and a thickness of 20 µm or more exhibits, in addition to higher gas barrier properties after retorting, higher stiffness and improved pinhole resistance, and is, therefore, particularly suitably used as a layer (A).

1. A multilayer structure in which a layer (A) made of a polyolefin resin composition (a), an oxygen barrier layer (B) and a sealant layer (C) are laminated in this sequence, wherein
the resin composition (a) comprises a polyolefin having a melting point of 130° C. or higher as a main component,
the layer (A) has a water vapor transmission rate of 10 g/m²•day or more at 40° C. and a humidity of 90%,
the layer (A) has a thickness of 5 to 150 µm, and
the layer (B) comprises an ethylene-vinyl alcohol copolymer as a main component.

2. The multilayer structure according to claim 1, further comprising a water-vapor barrier layer (D) between the layer (B) and layer (C), wherein
the layer (D) is a deposited aluminum layer or a deposited layer made of an inorganic oxide, and
all resin components contained in all layers have a melting point of 240° C. or lower, or amorphous.

3. The multilayer structure according to claim 1, wherein the polyolefin is a polymethylpentene or a polypropylene.

4. The multilayer structure according to claim 1, wherein the polyolefin is a polymethylpentene.

5. The multilayer structure according to claim 1, wherein the polyolefin is a polypropylene.

6. The multilayer structure according to claim 3, wherein the polyolefin resin composition (a) further comprises an ethylene-α-olefin copolymer or a hydrogenated styrene thermoplastic elastomer in 0.1 to 40% by mass.

7. The multilayer structure according to claim 1, wherein the layer (A) is stretched by 2 to 15 times at least in one direction.

8. The multilayer structure according to claim 1, wherein the layer (A) has a density of 0.83 to 0.90 g/cm³.

9. The multilayer structure according to claim 1, wherein the layer (A) is porous.

10. The multilayer structure according to claim 1, wherein an ethylene unit content of the ethylene-vinyl alcohol copolymer is 20 to 60 mol%.

11. The multilayer structure according to claim 1, wherein the layer (B) further comprises an oxygen-absorbing resin.

12. The multilayer structure according to claim 11, wherein the oxygen-absorbing resin comprises a carbon-carbon double bond and the layer (B) comprises a transition metal catalyst.

13. The multilayer structure according to claim 11, wherein the oxygen-absorbing resin is a polyoctenylene or an ethylene-α-olefin-5-ethylidene-2-norbornene copolymer.

14. The multilayer structure according to claim 1, wherein the layer (B) comprises a layer (B1) and a layer (B2), and a difference in an ethylene unit content between the ethylene-vinyl alcohol copolymer contained in the layer (B1) and the ethylene-vinyl alcohol copolymer contained in the layer (B2) is 3 mol% or more.

15. The multilayer structure according to claim 1, wherein the layer (B) further comprises an aliphatic polyamide in 25 parts by mass or less based on 100 parts by mass of the ethylene-vinyl alcohol copolymer.

16. The multilayer structure according to claim 1, wherein the layer (C) comprises a polypropylene.

17. The multilayer structure according to claim 2, wherein the layer (D) has a thickness of 10 to 1000 nm.

18. The multilayer structure according to claim 1, wherein a total thickness is 10 to 200 µm.

19. A packaging container made of the multilayer structure according to claim 1.

20. The packaging container according to claim 19, which is a stand-up pouch.

21. The packaging container according to claim 19 for sterilization treatment with water vapor or hot water.

22. A package product, wherein a content is filled in the packaging container according to claim 21.

23. A sterilization treatment method comprising sterilizing the package product according to claim 22 with water vapor or hot water at 70° C. to 140° C.

24. A recovery method comprising melt-kneading the multilayer structure according to claim 1.
